(19) United States
(12) Patent Application Publication
(10) Pub. No.: US 2011/0176519 A1
(43) Pub. Date: Jul. 21, 2011

(54) Signalling of Multiple-User Multiple-Input and Multiple-Output Transmissions in High-Speed Packet Access Systems

(76) Inventors: Pavan Kumar Vitthaladevuni, San Diego, CA (US); Daniu Zhang, San Deigo, CA (US); Rohit Kapoor, San Diego, CA (US); Jilei Hou, Carlsbad, CA (US); Stefan Brueck, Nurembeng (DE); Josef J. Blanz, Forst (DE)

(21) Appl. No.: 12/946,705

(22) Filed: Nov. 15, 2010

Related U.S. Application Data
(60) Provisional application No. 61/262,115, filed on Nov. 17, 2009.

(51) Int. Cl. H04W 72/04; H04W 4/00

(52) U.S. Cl. 370/336; 370/328; 370/329

(57) ABSTRACT

A method for signaling multiple-user multiple-input and multiple-output in a high speed packet access system is described. A multiple-user multiple-input and multiple-output parameter is determined. A message that includes the multiple-user multiple-input and multiple-output parameter is determined. The message is sent to a wireless device. The method may be performed by a user equipment, a Node B or a radio network controller.

### RELATED APPLICATIONS

This application is related to and claims priority from U.S. Provisional Patent Application Ser. No. 61/262,115, filed Nov. 17, 2009, for “SIGNALING OF MU-MIMO TRANSMISSIONS FROM NODE-B.”

### TECHNICAL FIELD

The present disclosure relates generally to wireless communication systems. More specifically, the present disclosure relates to systems and methods for signaling of multiple-user multiple-input and multiple-output (MU-MIMO) transmissions in high-speed packet access (HSPA) systems.

### BACKGROUND

Wireless communication systems are widely deployed to provide various types of communication content such as voice, video, data, and so on. These systems may be multiple-access systems capable of supporting simultaneous communication of multiple terminals with one or more base stations.

A problem that must be dealt with in all communication systems is fading or other interference. There may be problems with decoding the signals received. One way to deal with these problems is by utilizing beamforming. With beamforming, instead of using each transmit antenna to transmit a spatial stream, the transmit antennas each transmit a linear combination of the spatial streams, with the combination being chosen so as to optimize the response at the receiver.

Smart antennas are arrays of antenna elements, each of which receive a signal to be transmitted with a predetermined phase offset and relative gain. The net effect of the array is to direct a (transmit or receive) beam in a predetermined direction. The beam is steered by controlling the phase and gain relationships of the signals that excite the elements of the array. Thus, smart antennas direct a beam to each individual mobile unit (or multiple mobile units) as opposed to radiating energy to all mobile units within a predetermined coverage area (e.g., 120°) as conventional antennas typically do. Smart antennas increase system capacity by decreasing the width of the beam directed at each mobile unit and thereby decreasing interference between mobile units. Such reductions in interference result in increases in signal-to-interference and signal-to-noise ratios that improve performance and/or capacity. In power controlled systems, directing narrow beam signals at each mobile unit also results in a reduction in the transmit power required to provide a given level of performance.

Wireless communication systems may use beamforming to provide system-wide gains. In beamforming, multiple antennas on the transmitter may steer the direction of transmissions towards multiple antennas on the receiver. Beamforming may reduce the signal-to-noise ratio (SNR). Beamforming may also decrease the amount of interference received by terminals in neighboring cells. Benefits may be realized by providing improved beamforming techniques.

### SUMMARY

A method for signaling multiple-user multiple-input and multiple-output in a high speed packet access system is described. A multiple-user multiple-input and multiple-output parameter is determined. A message that includes the multiple-user multiple-input and multiple-output parameter is generated. The message is sent to a wireless device.

The method may be performed by a radio network controller. The wireless device may be a Node B that forwards the message to a user equipment. The multiple-user multiple-input and multiple-output parameter may include a user equipment multiple-user multiple-input and multiple-output configuration required of the user equipment to support multiple-user multiple-input and multiple-output operations. The message may be a radio resource control message.

The multiple-user multiple-input and multiple-output parameter may also include a channel quality indicator report configuration. The multiple-user multiple-input and multiple-output parameter may further include a high-speed shared control channel fields reinterpretation. The method may be performed by a user equipment. The wireless device may then be a Node B that forwards the message to a radio network controller.

The multiple-user multiple-input and multiple-output parameter may include a multiple-user multiple-input and multiple-output operation capability of the user equipment. The message may be a radio resource control message. The multiple-user multiple-input and multiple-output parameter may include a multiple-user multiple-input and multiple-output capable user equipment category.

The method may be performed by a Node B. The wireless device may be a radio network controller. The multiple-user multiple-input and multiple-output parameter may include a Node B multiple-user multiple-input and multiple-output scheduling capability.

The multiple-user multiple-input and multiple-output parameter may include a multiple-user multiple-input and multiple-output capability and configuration of a user equipment being served by the Node B. The multiple-user multiple-input and multiple-output parameter may also include a new high-speed shared control channel fields encoding.

The wireless device may be a user equipment. The multiple-user multiple-input and multiple-output parameter may include multiple-user multiple-input and multiple-output scheduling information that is sent for each transmission time interval. The multiple-user multiple-input and multiple-output scheduling information may be sent via a high-speed shared control channel on a common high speed downlink shared channel—radio network temporary identifier, via certain bits of a channelization code set of a high-speed shared control channel or via a Type-3 dual stream high-speed shared control channel with a secondary transport block size set to 111111 and a corresponding redundancy version set to 0.

The user equipment may be transmit antenna array capable. The multiple-user multiple-input and multiple-output scheduling information may be sent via a combination of a modulation scheme and a number of transport blocks in a high-speed shared control channel. The multiple-user multiple-input and multiple-output scheduling information may also be sent via a hybrid automatic repeat request processing identification in a high-speed shared control channel.

The multiple-user multiple-input and multiple-output parameter may include a command to activate/deactivate multiple-user multiple-input and multiple-output operations on the user equipment. The message may be a high-speed shared control channel order. The high-speed shared control channel order may include a channel quality indicator reporting change for the user equipment or a high-speed shared control channel fields interpretation change for the user equipment.

A wireless device configured for signaling multiple-user multiple-input and multiple-output in a high speed packet access system is also described. The wireless device includes a processor, memory in electronic communication with the processor and instructions stored in the memory. The instructions are executable by the processor to determine a multiple-user multiple-input and multiple-output parameter. The instructions are also executable by the processor to generate a message that includes the multiple-user multiple-input and multiple-output parameter. The instructions are further executable by the processor to send the message to a second wireless device.

A wireless device configured for signaling multiple-user multiple-input and multiple-output in a high speed packet access system is described. The wireless device includes means for determining a multiple-user multiple-input and multiple-output parameter. The wireless device also includes means for generating a message that includes the multiple-user multiple-input and multiple-output parameter. The wireless device further includes means for sending the message to a wireless device.

A computer-program product for signaling multiple-user multiple-input and multiple-output in a high-speed packet access system is also described. The computer-program product includes a non-transitory computer-readable medium having instructions thereon. The instructions include code for causing a first wireless device to determine a multiple-user multiple-input and multiple-output parameter. The instructions also include code for causing a first wireless device to generate a message that comprises the multiple-user multiple-input and multiple-output parameter. The instructions further include code for causing the first wireless device to send the message to a second wireless device.

### BRIEF DESCRIPTION OF THE DRAWINGS

FIG. 1 shows a wireless communication system with multiple wireless devices;

FIG. 2 shows another wireless communication system with multiple wireless devices;

FIG. 3 is a flow diagram of a method for adjusting a data rate to account for inter-stream interference (ISI) in both single-user multiple-input and multiple-output (SU-MIMO) transmissions and multiple-user multiple-input and multiple-output (MU-MIMO) transmissions;

FIG. 4 is a block diagram illustrating a comparison table for pairing user equipments (UEs);

FIG. 5 is a block diagram illustrating a timeline with multiple transmission time intervals (TTIs);

FIG. 6 is a flow diagram of a method for sending channel quality indicator (CQI) feedback that accounts for inter-stream interference (ISI);

FIG. 7 is a timing diagram illustrating channel quality indicator (CQI) feedback cycles for user equipments (UEs);

FIG. 8 is a block diagram of a base station for use in the present systems and methods;

FIG. 9 is a block diagram of a wireless communication device for use in the present systems and methods;

FIG. 10 is a block diagram of a transmitter and receiver in a multiple-input and multiple-output (MIMO) system;

FIG. 11 is a block diagram illustrating a radio network operating according to Universal Mobile Telecommunications System (UMTS) standards;

FIG. 12 is a block diagram illustrating communications between a user equipment (UE), a Node B and a radio network controller (RNC) in a wireless communications network;

FIG. 13 is a flow diagram of a method for signaling a user equipment's (UE's) multiple-user multiple-input and multiple-output (MU-MIMO) operation capability from a user equipment (UE) to a radio network controller (RNC);

FIG. 14 is a flow diagram of a method for signaling a user equipment (UE) multiple-user multiple-input and multiple-output (MU-MIMO) configuration required to support multiple-user multiple-input and multiple-output (MU-MIMO) operations from a network to a user equipment (UE);

FIG. 15 is a block diagram illustrating communications between a Node B and a radio network controller (RNC) in a wireless communications network;

FIG. 16 is a flow diagram of a method for signaling the multiple-user multiple-input and multiple-output (MU-MIMO) capability and configuration of a user equipment (UE) from a radio network controller (RNC) to a Node B;

FIG. 17 is a flow diagram of a method for signaling a Node B multiple-user multiple-input and multiple-output (MU-MIMO) scheduling capability to a radio network controller (RNC);

FIG. 18 is a block diagram illustrating the transmission of a high-speed shared control channel (HS-SCCH) order from a Node B to a user equipment (UE) in a wireless communications network;

FIG. 19 is a flow diagram of a method for sending a high-speed shared control channel (HS-SCCH) order to a user equipment (UE);

FIG. 20 is a block diagram illustrating multiple-user multiple-input and multiple-output (MU-MIMO) scheduling transmitted from a Node B to a user equipment (UE) for every transmission time interval (TTI) in a wireless communications network;

FIG. 21 illustrates certain components that may be included within a base station;

FIG. 22 illustrates certain components that may be included within a wireless communication device; and

FIG. 23 illustrates certain components that may be included within a radio network controller (RNC).

### DETAILED DESCRIPTION

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices. In 3GPP LTE, a mobile station or device may be referred to as a “user equipment” (UE).

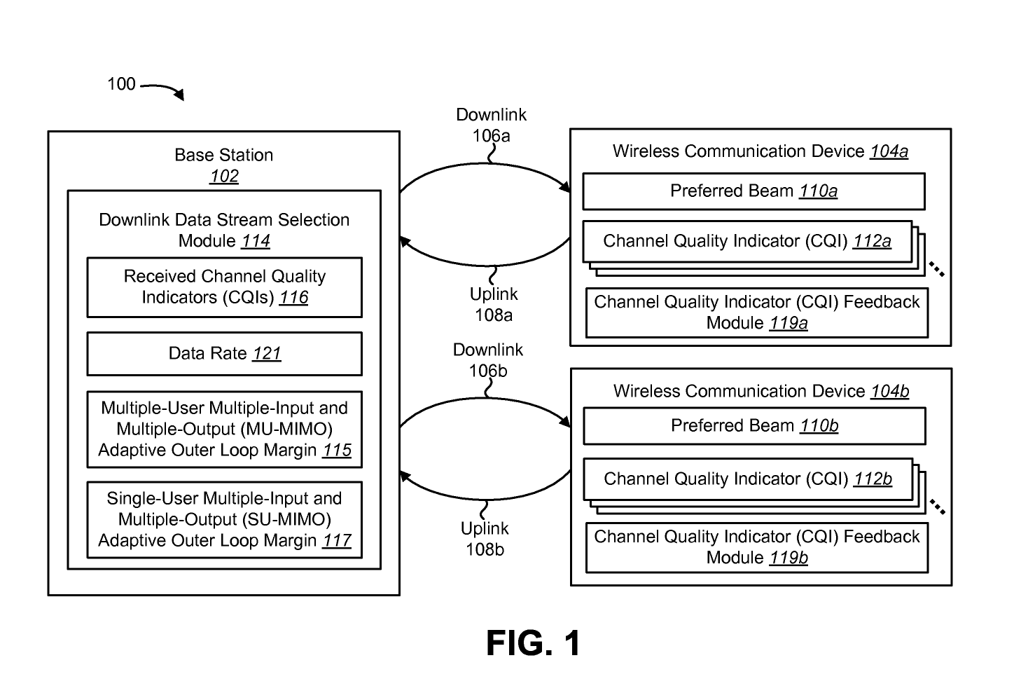

FIG. 1 shows a wireless communication system 100 with multiple wireless devices. Wireless communication systems 100 are widely deployed to provide various types of communication content such as voice, data, and so on. A wireless device may be a base station 102 or a wireless communication device 104.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “Base Station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (NT) transmit antennas and multiple (NR) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink 108a-b and downlink 106a-b transmissions are on the same frequency region so that the reciprocity principle allows the estimation of the downlink 106 channel from the uplink 108 channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). For clarity, certain aspects of the techniques are described below for LTE, and LTE terminology is used in much of the description below.

A base station 102 may communicate with one or more wireless communication devices 104. For example, the base station 102 may communicate with a first wireless communication device 104a and a second wireless communication device 104b. A wireless communication device 104 may also be referred to as, and may include some or all of the functionality of, a terminal, an access terminal, a user equipment (UE), a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one, or multiple base stations 102 on the downlink 106 and/or uplink 108 at any given moment. The downlink 106 (or forward link) refers to the communication link from a base station 102 to a wireless communication device 104, and the uplink 108 (or reverse link) refers to the communication link from a wireless communication device 104 to a base station 102.

3GPP Release 5 and later supports High-Speed Downlink Packet Access (HSDPA). 3GPP Release 6 and later supports High-Speed Uplink Packet Access (HSUPA). HSDPA and HSUPA are sets of channels and procedures that enable high-speed packet data transmission on the downlink and uplink. HSDPA and HSUPA are thus parts of the family of mobile telephony protocols named High-Speed Packet Access (HSPA). Release 7 HSPA+ uses three enhancements to improve data rate. First, support was introduced for 2×2 multiple-input and multiple-output (MIMO) on the downlink 106. With MIMO, the peak data rate supported on the downlink 106 is 28 megabits per second (Mbps). Second, higher order modulation was introduced on the downlink 106. The use of 64 quadrature amplitude modulation (QAM) on the downlink 106 allows peak data rates of 21 Mbps. Third, higher order modulation was introduced on the uplink 108. The use of 16 QAM on the uplink 108 allows peak data rates of 11 Mbps.

In HSUPA, the base station 102 may allow several wireless communication devices 104 to transmit at a certain power level at the same time (using grants). These grants are assigned to wireless communication devices 104 by using a fast scheduling algorithm that allocates the resources on a short-term basis (i.e., on the order of tens of milliseconds (ms)). The rapid scheduling of HSUPA is well suited to the bursty nature of packet data. During periods of high activity, a wireless communication device 104 may get a larger percentage of the available resources, while getting little or no bandwidth during periods of low activity.

In 3GPP Release 5 HSDPA, a base station 102 may send downlink payload data to wireless communication devices on the High-Speed Downlink Shared Channel (HS-DSCH). A base station 102 may also send the control information associated with the downlink data on the High-Speed Shared Control Channel (HS-SCCH). There are 256 Orthogonal Variable Spreading Factor (OVSF) codes (or Walsh codes) used for data transmission. In HSDPA systems, these codes are partitioned into Release 1999 (legacy system) codes that are typically used for cellular telephony (voice) and HSDPA codes that are used for data services. For each transmission time interval (TTI), the dedicated control information sent to an HSDPA-enabled wireless communication device 104 may indicate to the wireless communication device 104 which codes within the code space will be used to send downlink payload data to the wireless communication device 104 and the modulation that will be used for transmission of the downlink payload data.

With HSDPA operations, downlink transmissions to the wireless communication devices 104a-b may be scheduled for different transmission time intervals (TTIs) using the 15 available HSDPA Orthogonal Variable Spreading Factor (OVSF) codes. For a given transmission time interval (TTI), each wireless communication device 104 may be using one or more of the 15 HSDPA codes, depending on the downlink bandwidth allocated to the wireless communication device 104 during the transmission time interval (TTI). As discussed above, for each transmission time interval (TTI), the control information indicates to the wireless communication device 104 which codes within the code space will be used to send downlink payload data (data other than control data of the wireless communications system 100) to the wireless communication device 104, along with the modulation that will be used for the transmission of the downlink payload data.

Based on communications received from a base station 102, a wireless communication device 104 may generate one or more channel quality indicators (CQIs) 112a-b. Each channel quality indicator (CQI) 112 may be a channel measurement for the downlink 106 channel between the base station 102 and the wireless communication device 104. A channel quality indicator (CQI) 112 may be dependent on the transmission scheme used in the wireless communications system 100. Because multiple-input and multiple-output (MIMO) communication is used between the base station 102 and the wireless communication device 104, each channel quality indicator (CQI) 112 may correspond to a different downlink 106 channel (i.e., a different transmit antenna and receive antenna pair) between the base station 102 and the wireless communication device 104.

A wireless communication device 104 may use the channel quality indicators (CQIs) 112 to determine a preferred beam 110a-b. A preferred beam 110 may refer to the antenna structure, weight, transmission direction and phase of a signal transmitted by the base station 102 to the wireless communication device 104. The terms “beam” and “precoding vector” may refer to the direction in which data is streamed wirelessly from an antenna. In multiple-input and multiple-output (MIMO), multiple beams may be used to transmit information between a base station 102 and a wireless communication device 104. A preferred beam may thus refer to a beam that produces the best (i.e., the optimal) data stream between the base station 102 and the wireless communication device 104.

In Release 7 of HSPA, single-user MIMO (SU-MIMO) is used. When a wireless communication device 104 has good geometry (i.e., the wireless communication device 104 is in a good position relative to the base station 102), the wireless communication device 104 may request dual-stream transmissions from the base station 102. In dual-stream transmissions, the base station 102 may transmit a first data stream and a second data stream to a wireless communication device 104 during a transmission time interval (TTI). The first data stream and the second data stream may be transmitted on orthogonal antenna beams. It is inherent that one of the data streams (i.e., a preferred data stream) will have a higher throughput than the other. When a MIMO-capable wireless communication device 104 requests dual-stream transmission, the channel quality indicator (CQI) 112 of the preferred beam may be higher than that of an orthogonal beam used in addition to the preferred beam. Hence, transmitting on both data streams to a wireless communication device 104 may not result in the most efficient resource usage.

In contrast, multiple-user MIMO (MU-MIMO) may increase user throughputs on the downlink 106 over traditional SU-MIMO by making more intelligent use of the base station 102 resources. MU-MIMO may enable an increase in throughput for a particular transmission time interval (TTI) compared to dual-stream transmission to a single wireless communication device 104. The downlink data stream selection module 114 may thus determine whether to use dual downlink data streams for a single wireless communication device 104 (i.e., SU-MIMO) or to use a first data stream for a first wireless communication device 104a and a second data stream that is orthogonal to the first data stream for a second wireless communication device 104b (i.e., MU-MIMO).

A channel quality indicator (CQI) 112 may correspond to a request for a single-stream transmission or a dual-stream transmission. As discussed above, a wireless communication device 104 may include multiple channel quality indicators (CQIs) 112. The wireless communication device 104 may generate multiple channel quality indicators (CQIs) 112 for each transmission time interval (TTI). A wireless communication device 104 may not send every channel quality indicator (CQI) 112 to the base station 102 for every transmission time interval (TTI). In the current standard, a wireless communication device 104 may send only the optimal channel quality indicator (CQI) 112 to the base station 102 for each transmission time interval (TTI).

If the wireless communication device 104 determines that it has good geometry with respect to the base station 102 (i.e., the channel quality between the base station 102 and the wireless communication device 104 is above a threshold), the wireless communication device 104 may send an optimal dual-stream multiple-input and multiple-output (MIMO) channel quality indicator (CQI) 112 to the base station 102. If the wireless communication device 104 determines that it has bad geometry with respect to the base station 102 (i.e., the channel quality between the base station 102 and the wireless communication device 104 is below the threshold), the wireless communication device 104 may send an optimal single-stream multiple-input and multiple-output (MIM) channel quality indicator (CQI) 112 to the base station 102.

However, these channel quality indicators (CQIs) 112 do not take into account inter-stream interference (ISI). Inter-stream interference (ISI) refers to the interference that may occur when the base station 102 transmits multiple data streams simultaneously. If inter-stream interference (ISI) is not taken into account, a base station 102 may use a bit rate that the wireless communication device 104 is unable to decode.

Each wireless communication device 104 may include a channel quality indicator (CQI) feedback module 119a-b. A channel quality indicator (CQI) feedback module 119 may be used by the wireless communication device 104 to determine what channel quality indicator (CQI) 112 to send to the base station 102. The channel quality indicator (CQI) feedback module 119 may generate some single-stream channel quality indicators (CQIs) 112 that are adjusted to account for inter-stream interference (ISI). In one configuration, the channel quality indicator (CQI) feedback module 119 may alternate between sending a channel quality indicator (CQI) 112 generated using Release 7 and a channel quality indicator (CQI) 112 adjusted for inter-stream interference (ISI) for each transmission time interval (TTI).

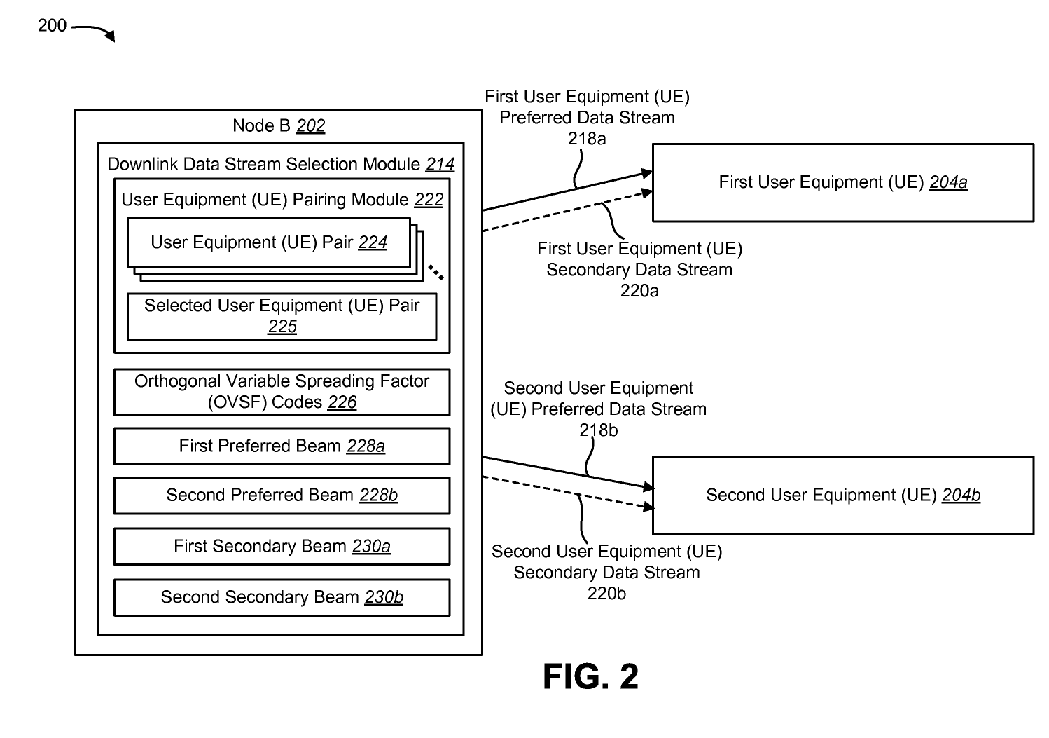

A wireless communication device 104 may transmit the channel quality indicators (CQIs) 112 to the base station 102 via the uplink 108 channel. The base station 102 may thus receive channel quality indicators (CQI) 116 from many wireless communication devices 104 corresponding to many downlink 106 channels. The base station 102 may include a downlink data stream selection module 114. The downlink data stream selection module 114 may include the received channel quality indicators (CQIs) 116. The downlink data stream selection module 114 may use the received channel quality indicators (CQIs) 116 to determine scheduling for each wireless communication device 104. The downlink data stream selection module 114 is discussed in further detail below in relation to FIG. 2.

The downlink data stream selection module 114 may include a data rate 121. The data rate 121 may refer to the bit rate of a downlink 106 data stream. The downlink data stream selection module 114 may also include a multiple-user multiple-input and multiple output (MU-MIMO) adaptive outer loop margin 115. The multiple-user multiple-input and multiple-output (MU-MIMO) adaptive outer loop margin 115 may be an adjustment that the base station 102 applies to the data rate 121 for each channel quality indicator (CQI) 112 feedback cycle. If the channel quality indicator (CQI) 112 feedback cycle is 1, a wireless communication device 104 may report a channel quality indicator (CQI) 112 for each transmission time interval (TTI).

The multiple-user multiple-input and multiple-output (MU-MIMO) adaptive outer loop margin 115 may be used by the base station 102 to increase or decrease the data rate 121 when a wireless communication device 104 sends a single-stream channel quality indicator (CQI) 112 and the base station 102 has determined to use a multiple-user multiple-input and multiple-output (MU-MIMO) transmissions.

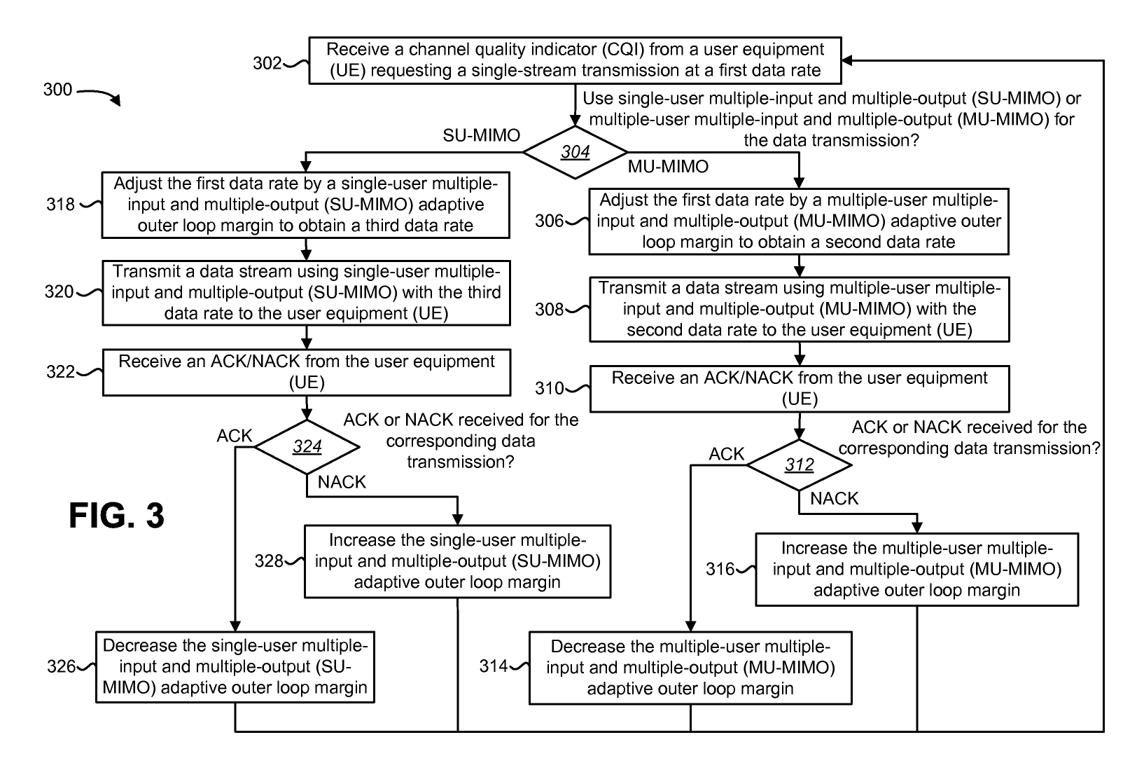

The downlink data stream selection module 114 may also include a single-user multiple-input and multiple-output (SU-MIMO) adaptive outer loop margin 117. The single-user multiple-input and multiple-output (SU-MIMO) adaptive outer loop margin 117 may be used by the base station 102 to increase or decrease the data rate 121 when a wireless communication device 104 has requested either a single-stream or a dual-stream transmission and the base station 102 determines to use a single-user multiple-input and multiple-output (SU-MIMO) transmission or when the wireless communication device 104 has requested a dual-stream transmission and the base station 102 determines to use a multiple-user multiple-input and multiple-output (MU-MIMO) transmission. Both the single-user multiple-input and multiple-output (SU-MIMO) adaptive outer loop margin 117 and the multiple-user multiple-input and multiple-output (MU-MIMO) adaptive outer loop margin 115 may be adjusted/updated based upon the reception of a positive-acknowledgement/negative-acknowledgement (ACK/NACK) from a wireless communication device 104. Single-user multiple-input and multiple-output (SU-MIMO) adaptive outer loop margins 117 and multiple-user multiple-input and multiple-output (MU-MIMO) adaptive outer loop margins 115 are discussed in additional detail below in relation to FIG. 3.

FIG. 2 shows another wireless communication system 200 with multiple wireless devices. The wireless communication system 200 may include a Node B 202. The Node B 202 of FIG. 2 may be one configuration of the base station 102 of FIG. 1. The wireless communication system 200 may also include a first user equipment (UE) 204a and a second user equipment (UE) 204b. The first user equipment (UE) 204a and the second user equipment (UE) 204b of FIG. 2 may be one configuration of the wireless communication devices 104a-b of FIG. 1.

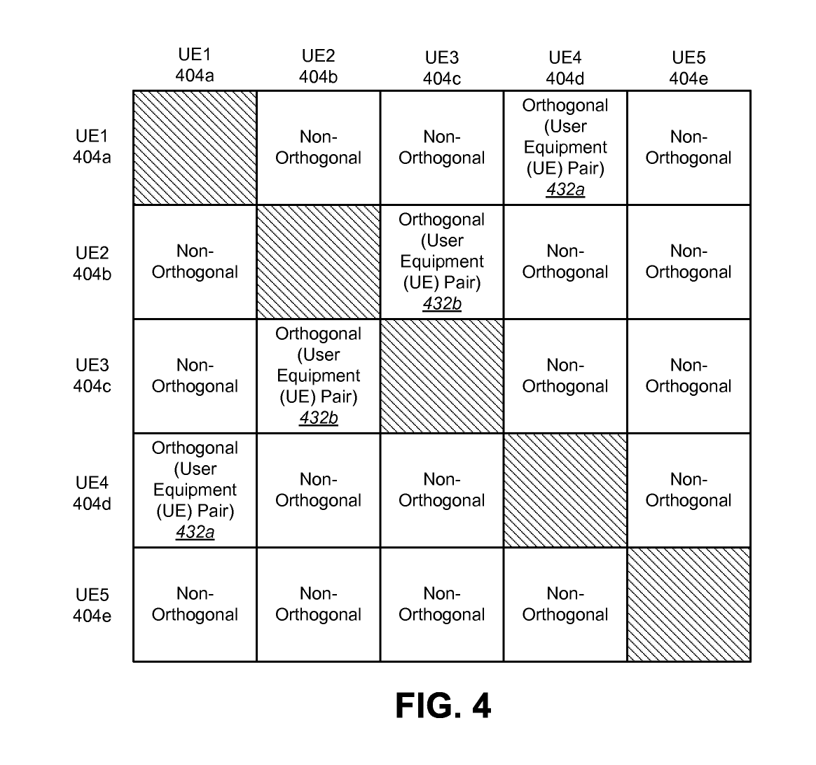

The Node B 202 may include a downlink data stream selection module 214. The downlink data stream selection module 214 of FIG. 2 may be one configuration of the downlink data stream selection module 114 of FIG. 1. The downlink data stream selection module 214 may include a user equipment (UE) pairing module 222. The user equipment (UE) pairing module 222 may determine one or more user equipment (UE) pairs 224. A user equipment (UE) pair 224 may refer to two user equipments (UEs) 204 with preferred data streams 218 that are orthogonal to each other. User equipment (UE) pairs 224 are discussed in additional detail below in relation to FIG. 4. The Node B 202 may also include a selected user equipment (UE) pair 225. Since the Node B 202 can only transmit two orthogonal data streams at a time, only one user equipment (UE) pair 224 may be selected as the user equipment (UE) pair 225. Optimization procedures may be used to determine the selected user equipment (UE) pair 225.

The Node B 202 may select a user equipment (UE) pair 224 as the selected user equipment (UE) pair 225. In one configuration, the Node B 202 may select a user equipment (UE) pair 224 if the sum rate of data streams for two different user equipments (UEs) 204 is larger than the UE-specific sum rate of the two data streams. For example, if the first user equipment (UE) 204a requests two data streams, the first user equipment (UE) 204a may report a preferred primary precoding vector b1 and the two channel quality indicators (CQIs) 112 CQI1 and CQI2 that correspond to the preferred (strong) data stream 218a and the secondary (weak) data stream 220, respectively. Similarly, if the second user equipment (UE) 204b requests two streams of data, the second user equipment (UE) 204b may report a preferred primary precoding vector b2 and channel quality indicators (CQIs) 112 CQI1′ and CQI2′ for both data streams.

The preferred secondary precoding vector (that is orthogonal to b1) is b2 and may be known by the base station 102 based on the preferred primary precoding vector b1. If CQI1>CQI1′ and CQI2>CQI2′, the first user equipment (UE) preferred data stream 218a may be mapped to precoding vector b1 and the second user equipment (UE) preferred data stream 218b may be mapped to precoding vector b2. The base station 102 may only be capable of sending a maximum of two data streams in a given transmission time interval (TTI) on orthogonal beams. Therefore, only user equipments (UEs) 204 that have orthogonal preferred beams 228 may be paired.

If both the first user equipment (UE) 204a and the second user equipment (UE) 204b request beams b1 and b2, the Node B 202 may pair the two user equipments (UEs) 204 on beams b1 and b2. If the Node B 202 finds this pairing to be maximizing a certain metric during the transmission time interval (TTI), the Node B 202 may schedule data streams to the selected user equipment (UE) pair 225 in the same transmission time interval (TTI) using the same orthogonal variable spreading factor (OVSF) codes 226. An orthogonal variable spreading factor (OVSF) code 226 is an orthogonal code that facilitates uniquely identifying individual communication channels. One example of a metric that may be maximized is the sum proportional fair metric. In the sum proportional fair metric, the proportional fair metrics per stream are summed whenever MU-MIMO transmission is considered. Other metrics may also be used.

The Node B 202 may communicate with the first user equipment (UE) 204a during a first transmission time interval (TTI) using SU-MIMO. For example, the Node B 202 may transmit a first user equipment (UE) preferred data stream 218a to the first user equipment (UE) 204a using a first preferred beam 228a. The Node B 202 may also transmit a first user equipment (UE) secondary data stream 220a to the first user equipment (UE) 204a using a first secondary beam 230a. The first preferred beam 228a and the first secondary beam 230a may be orthogonal to each other.

During a second transmission time interval (TTI), the Node B 202 may communicate with the second user equipment (UE) 204b. For example, the Node B 202 may transmit a second user equipment (UE) preferred data stream 218b to the second user equipment (UE) 204b using a second preferred beam 228b. The Node B 202 may also transmit a second user equipment (UE) secondary data stream 220b to the second user equipment (UE) 204b using a second secondary beam 230b. The second preferred beam 228b and the second secondary beam 230b may be orthogonal to each other.

Sending two data streams on orthogonal beams to the same user equipment (UE) 204 may not result in the best resource usage for the wireless communication system 200. In other words, sending two data streams on orthogonal beams to the same user equipment (UE) 204 may not allocate power in the Node B 202 in the most efficient way because the preferred data stream 218 has a stronger channel quality indicator (CQI) 112 than a secondary data stream 220. If the same amount of power is used to transmit each data stream, throughput for the secondary data stream 220 will be lower than throughput for the preferred data stream 218 (due to the secondary data stream 220 having a lower channel quality indicator (CQI)) 112.

By using MU-MIMO instead of SU-MIMO, user throughputs on the downlink 106 may be increased by more intelligently using the resources of the Node B 202. In MU-MIMO, the Node B 202 may find a first user equipment (UE) 204a and a second user equipment (UE) 204b with preferred beams 228 that are orthogonal to each other. The first user equipment (UE) 204a and the second user equipment (UE) 204b may be referred to as a user equipment (UE) pair 224.

Instead of transmitting a dual stream (i.e., a preferred data stream 218 and a secondary data stream 220) during one transmission time interval (TTI) to a user equipment (UE) 204, the Node B 202 may transmit a first user equipment (UE) preferred data stream 218a to the first user equipment (UE) 204a while simultaneously transmitting a second user equipment (UE) preferred data stream 218b to the second user equipment (UE) 204b. Thus, the Node B 202 may refrain from transmitting a first user equipment (UE) secondary data stream 220a and a second user equipment (UE) secondary data stream 220b. The Node B 202 may transmit the first user equipment (UE) preferred data stream 218a and the second user equipment (UE) preferred data stream 218b using the same codes (e.g., an orthogonal variable spreading factor (OVSF) code 226 with a spreading factor of sixteen). Because the Node B 202 does not have to allocate power to a data stream with lower throughput, the throughput for the wireless communication system 200 may be improved.

The Node B 202 may transmit the first user equipment (UE) preferred data stream 218a using a first preferred beam 228a. The Node B 202 may transmit the first user equipment (UE) secondary data stream 220a using a first secondary beam 230a. The Node B 202 may transmit the second user equipment (UE) preferred data stream 218b using a second preferred beam 228b. The Node B 202 may also transmit the second user equipment (UE) secondary data stream 220b using a second secondary beam 230b. If the first user equipment (UE) 204a and the second user equipment (UE) 204b are a user equipment (UE) pair 224, then the first preferred beam 228a and the second preferred beam 228b are orthogonal.

FIG. 3 is a flow diagram of a method 300 for adjusting a data rate 121 to account for inter-stream interference (ISI) in both single-user multiple-input and multiple-output (SU-MIMO) transmissions and multiple-user multiple-input and multiple-output (MU-MIMO) transmissions. The method 300 may be performed by a base station 102. In one configuration, the base station 102 may be a Node B 202. The method 300 of FIG. 3 requires no channel quality indicator (CQI) 112 reporting changes to the user equipments (UEs) 204 in communication with the base station 102.

The base station 102 may receive 302 a channel quality indicator (CQI) 112 from a user equipment (UE) 204 requesting a single-stream transmission at a first data rate 121. This channel quality indicator (CQI) 112 may not take into account the inter-stream interference (ISI) that may occur if the base station 102 uses a dual-stream transmission. If the channel quality indicator (CQI) 112 received is requesting a dual-stream transmission, the method 300 does not apply. This is because a user equipment (UE) 204 requesting dual-stream transmission requests a particular bit rate from the base station 102 on each stream that takes the inter-stream interference (ISI) into account.

After receiving a channel quality indicator (CQI) 112, the base station 102 may determine 304 whether to use single-user multiple-input and multiple-output (SU-MIMO) or multiple-user multiple-input and multiple-output (MU-MIMO) for the data transmission. The base station 102 may use a ranking algorithm to determine whether to use single-user multiple-input and multiple-output (SU-MIMO) or multiple-user multiple-input and multiple-output (MU-MIMO) for the data transmission. The ranking algorithm is discussed in additional detail below.

If the base station 102 determines to use multiple-user multiple-input and multiple-output (MU-MIMO) for the data transmission, the base station 102 may adjust 306 the first data rate 121 by a multiple-user multiple-input and multiple-output (MU-MIMO) adaptive outer loop margin 115 to obtain a second data rate 121. The multiple-user multiple-input and multiple-output (MU-MIMO) adaptive outer loop margin 115 may be positive or negative in the dB (logarithmic) domain. The multiple-user multiple-input and multiple-output (MU-MIMO) adaptive outer loop margin 115 may be additive in the logarithm domain and multiplicative in the linear domain. In one configuration, the multiple-user multiple-input and multiple-output (MU-MIMO) adaptive outer loop margin 115 may not be constant; instead the multiple-user multiple-input and multiple-output (MU-MIMO) adaptive outer loop margin 115 may be updated whenever an ACK/NACK is received. In another configuration, the multiple-user multiple-input and multiple-output (MU-MIMO) adaptive outer loop margin 115 may be a constant. The base station 102 may then transmit 308 a data stream using multiple-user multiple-input and multiple-output (MU-MIMO) with the second data rate 121 to the user equipment (UE) 204.

The base station 102 may receive 310 an ACK/NACK from the user equipment (UE) 204. The base station 102 may then determine 312 whether an ACK or a NACK was received for the corresponding data transmission. If an ACK was received (i.e., the user equipment (UE) 204 was able to successfully decode the data transmission), the base station 102 may decrease 314 the multiple-user multiple-input and multiple-output (MU-MIMO) adaptive outer loop margin 115. In one configuration, the base station 102 may incrementally decrease 314 the multiple-user multiple-input and multiple-output (MU-MIMO) adaptive outer loop margin 115. In yet another configuration, the base station 102 may decrease 314 the multiple-user multiple-input and multiple-output (MU-MIMO) adaptive outer loop margin 115 using a function. The base station 102 may then wait to receive 302 another channel quality indicator (CQI) 112 from a user equipment (UE) 204.

If a NACK was received (i.e., the user equipment (UE) 204 was unable to successfully decode the data transmission), the base station 102 may increase 316 the multiple-user multiple-input and multiple-output (MU-MIMO) adaptive outer loop margin 115. In one configuration, the base station 102 may incrementally increase 316 the multiple-user multiple-input and multiple-output (MU-MIMO) adaptive outer loop margin 115. In yet another configuration, the base station 102 may increase 316 the multiple-user multiple-input and multiple-output (MU-MIMO) adaptive outer loop margin 115 using a function. The base station 102 may then wait to receive 302 another channel quality indicator (CQI) 112 from a user equipment (UE) 204.

If the base station 102 determines to use single-user multiple-input and multiple-output (SU-MIMO) for the data transmission, the base station 102 may adjust 318 the first data rate 121 by a single-user multiple-input and multiple-output (SU-MIMO) adaptive outer loop margin 117 to obtain a third data rate 121. The single-user multiple-input and multiple-output (SU-MIMO) adaptive outer loop margin 117 may be positive or negative in the dB (logarithmic) domain. The single-user multiple-input and multiple-output (SU-MIMO) adaptive outer loop margin 117 may be additive in the logarithm domain and multiplicative in the linear domain. In one configuration, the single-user multiple-input and multiple-output (SU-MIMO) adaptive outer loop margin 117 may not be constant; instead the single-user multiple-input and multiple-output (SU-MIMO) adaptive outer loop margin 117 may be updated whenever an ACK/NACK is received. In another configuration, the single-user multiple-input and multiple-output (SU-MIMO) adaptive outer loop margin 117 may be a constant. The base station 102 may then transmit 320 a data stream using single-user multiple-input and multiple-output (SU-MIMO) with the third data rate 121 to the user equipment (UE) 204.

The base station 102 may receive 322 an ACK/NACK from the user equipment (UE) 204. The base station 102 may then determine 324 whether an ACK or a NACK was received for the corresponding data transmission. If an ACK was received (i.e., the user equipment (UE) 204 was able to successfully decode the data transmission), the base station 102 may decrease 326 the single-user multiple-input and multiple-output (SU-MIMO) adaptive outer loop margin 117. In one configuration, the base station 102 may incrementally decrease 326 the single-user multiple-input and multiple-output (SU-MIMO) adaptive outer loop margin 117. In yet another configuration, the base station 102 may decrease 326 the single-user multiple-input and multiple-output (SU-MIMO) adaptive outer loop margin 117 using a function. The base station 102 may then wait to receive 302 another channel quality indicator (CQI) 112 from a user equipment (UE) 204.

If a NACK was received (i.e., the user equipment (UE) 204 was unable to successfully decode the data transmission), the base station 102 may increase 328 the single-user multiple-input and multiple-output (SU-MIMO) adaptive outer loop margin 117. In one configuration, the base station 102 may incrementally increase 328 the single-user multiple-input and multiple-output (SU-MIMO) adaptive outer loop margin 117. In yet another configuration, the base station 102 may increase 328 the single-user multiple-input and multiple-output (SU-MIMO) adaptive outer loop margin 117 using a function. The base station 102 may then wait to receive 302 another channel quality indicator (CQI) 112 from a user equipment (UE) 204.

Because the single-user multiple-input and multiple-output (SU-MIMO) adaptive outer loop margin 117 and the multiple-user multiple-input and multiple-output (MU-MIMO) adaptive outer loop margin 115 are dynamic, the method 300 of FIG. 3 may be referred to as the dual outer loop algorithm. One advantage of the dual outer loop algorithm is that no change to the channel quality indicator (CQI) 112 reporting protocol (e.g., the High-Speed Packet Access (HSPA) standards established by 3GPP) is required. One possible disadvantage may be that the single-user multiple-input and multiple-output (SU-MIMO) adaptive outer loop margin 117 and the multiple-user multiple-input and multiple-output (MU-MIMO) adaptive outer loop margin 115 may change relatively slowly, inhibiting optimal performance.

FIG. 4 is a block diagram illustrating a comparison table for pairing user equipments (UEs) 404. In the table, five user equipments (UEs) 404a-e are compared to determine user equipment (UE) pairs 432. Each of the user equipments (UEs) 404 is dual-stream capable. However, only the preferred beam 228 for each user equipment (UE) 404 is compared with the preferred beam 228 for each other user equipment (UE) 404.

A user equipment (UE) pair 432 occurs when the preferred beam 228 for one user equipment (UE) 404 is orthogonal to the preferred beam 228 for another user equipment (UE) 404. For example, the preferred beam 228 for UE1 404a may be orthogonal to the preferred beam 228 for UE4 404d. Thus, UE1 404a and UE4 404d are a user equipment (UE) pair 432a. As another example, the preferred beam 228 for UE2 404b may be orthogonal to the preferred beam 228 for UE3 404c. Thus, UE2 404b and UE3 404c are a user equipment (UE) pair 432b. If the preferred beams 228 for user equipments (UEs) 404 are not orthogonal, the matchup may be listed as non-orthogonal. A user equipment (UE) 404 may have a preferred beam 228 that is orthogonal to the preferred beams 228 of multiple user equipments (UEs) 404. A user equipment (UE) 404 may also have a preferred beam 228 that is orthogonal to none of the preferred beams 228 of the user equipments (UEs) 404 available for pairing. For example, UE5 404e is shown as having a preferred beam 228 that is non-orthogonal to the preferred beams 228 of the other user equipments (UEs) 404.

In case of multiple user equipment (UE) pairs 432, a base station 102 may select one of the user equipment (UE) pairs 432. Many different methods may be used for selecting one of the user equipment (UE) pairs 432. For example, a sum proportional fair metric may be used.

Usually scheduling aims to maximize a utility function U(R₁(t), . . . , R_{N}(t)) by allocating resources per transmission time interval (TTI) to certain users. The utility function for proportional fairness is given in Equation (1):

$$U ( {R}_{1} ( t ) , … , {R}_{N} ( t ) ) = {\sum }_{i = 1}^{N} log ( {R}_{i} ( t ) ) max . \qquad ( 1 )$$

In Equation (1) Rᵢ(t) denotes the average throughput of user i at time t. Assuming one stream, Equation (1) is equivalent to the resource allocation rule per transmission time interval (TTI) in Equation (2):

$${max}_{{δ}_{i}} {\sum }_{i = 1}^{N} \frac{{δ}_{i} \cdot {r}_{i} ( t )}{{R}_{i} ( t )} , {δ}_{i} ∈ \{ 0 , 1 \} . \qquad ( 2 )$$

In Equation (2), rᵢ(t) denotes the instantaneous rate the offers to user i at time t and δᵢε{0,1} indicates the resource allocation to user i. The task of the scheduler is to allocate resources per transmission time interval (TTI) (i.e., to choose the indices δᵢ in order to maximize the utility function). The resource allocation rule can be generalized for SU-MIMO in Equation (3):

$${max}_{{δ}_{i}} {\sum }_{i = 1}^{N} \frac{{δ}_{i} {\sum }_{j = 1}^{M} {r}_{ij} ( t )}{{R}_{i} ( t )} , {δ}_{i} ∈ \{ 0 , 1 \} . \qquad ( 3 )$$

For a 2×2 MU-MIMO, the rule to pair the users i₁ and i₂ is given in Equation (4):

$${max}_{{{i}_{1} , {i}_{2} ∈ [ 1 … , , , … N ]}_{{i}_{1} \neq {i}_{2}}} ( max ( \frac{{r}_{{i}_{1} 1} ( t )}{{R}_{{i}_{1}} ( t )} + \frac{{r}_{{i}_{2} 2} ( t )}{{R}_{{i}_{2}} ( t )} ; \frac{{r}_{{i}_{1} 2} ( t )}{{R}_{{i}_{1}} ( t )} + \frac{{r}_{{i}_{2} 1} ( t )}{{R}_{{i}_{2}} ( t )} ) ) . \qquad ( 4 )$$

The pairing algorithm decides which users and streams are paired per transmission time interval (TTI) according to the MU-MIMO proportional fair rule. The pairing algorithm then determines V precoding vectors bₖ, k=1 . . . 4 and all candidate users uⱼ per transmission time interval (TTI). The candidate sets are U(bₖ)={(uⱼ, CQI(bₖ)}, where bₖ is a preferred primary precoding vector for uⱼ. Candidate users do not require a rank-2 CQI report. Precoding vectors bₖ and b₅₋ₖ are assumed to be orthogonal. The user pairs for MU-MIMO transmission may then be determined using one or more approaches. In a first approach, the user pairs (uᵢ, uⱼ)ε(U(bₖ),U(b₅₋ₖ)) can be scheduled. For linear receivers, the preferred precoding vector offers a better CQI. This approach works irrespective of the receiver architecture.

A ranking algorithm may then be used. The ranking algorithm may identify per transmission time interval (TTI) the highest prioritized MU-MIMO pairs and the highest prioritized SU-MIMO users. A user is called eligible if it has a free HARQ process and data in its MAC priority queue(s). The reported CQI (quantized signal to noise ratio (SNR) in decibels (dB)) may be mapped to a spectral efficiency (in bits/symbol) for each eligible user.

An SU-MIMO user ranking list may then be calculated for all eligible users according to the proportional fair rule. Single or dual stream SU-MIMO may be assumed for each eligible user depending on the reported channel rank. The highest prioritized MU-MIMO eligible pair according to the user pairing approach may be determined according to the proportional fair rule. If needed, the spectral efficiencies may be rescaled to account for the power split between the paired users. Based on a priority comparison, either the highest prioritized user from the SU-MIMO ranking list or the highest prioritized MU-MIMO user pair may be scheduled in the instantaneous transmission time interval (TTI) (assuming that only one user for SU-MIMO or one user pair for MU-MIMO is scheduled per transmission time interval (TTI)). A CQI mapping table may then be used.

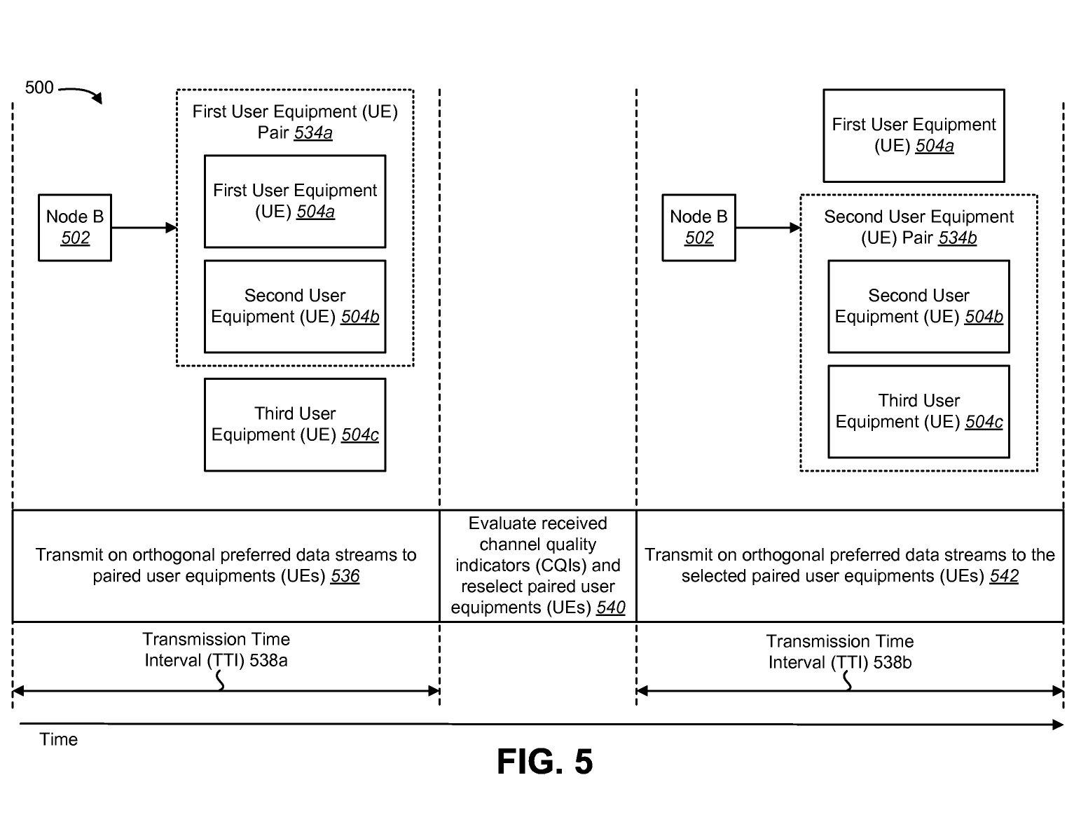

FIG. 5 is a block diagram illustrating a timeline 500 with multiple transmission time intervals (TTIs) 538. A Node B 502 may communicate with a first user equipment (UE) 504a, a second user equipment (UE) 504b and a third user equipment (UE) 504c. During a first transmission time interval (TTI) 538a, the first user equipment (UE) 504a and the second user equipment (UE) 504b may be part of a first user equipment (UE) pair 534a. The Node B 502 may transmit 536 on orthogonal preferred data streams 218 to the first user equipment (UEs) pair 534 (i.e., to the first user equipment (UE) 504a using a first user equipment (UE) preferred data stream 218a and to the second user equipment (UE) 504b using a second user equipment (UE) preferred data stream 218b) during the first transmission time interval (TTI) 538a.

After the first transmission time interval (TTI) 538a, the Node B 502 may evaluate 540 received channel quality indicators (CQIs) 112 and reselect the user equipment (UE) pair 534. For example, the Node B 502 may select a second user equipment (UE) pair 534b for a second transmission time interval (TTI) 538b. The second user equipment (UE) pair 534b may include the second user equipment (UE) 504b and the third user equipment (UE) 504c. The Node B 502 may then transmit 542 on the orthogonal preferred data streams 218 to the selected user equipment (UE) pair 534b (i.e., to the second user equipment (UE) 504b using a second user equipment (UE) preferred data stream 218b and to the third user equipment (UE) 504c using a third user equipment (UE) preferred data stream (not shown)) during the second transmission time interval (TTI) 538b.

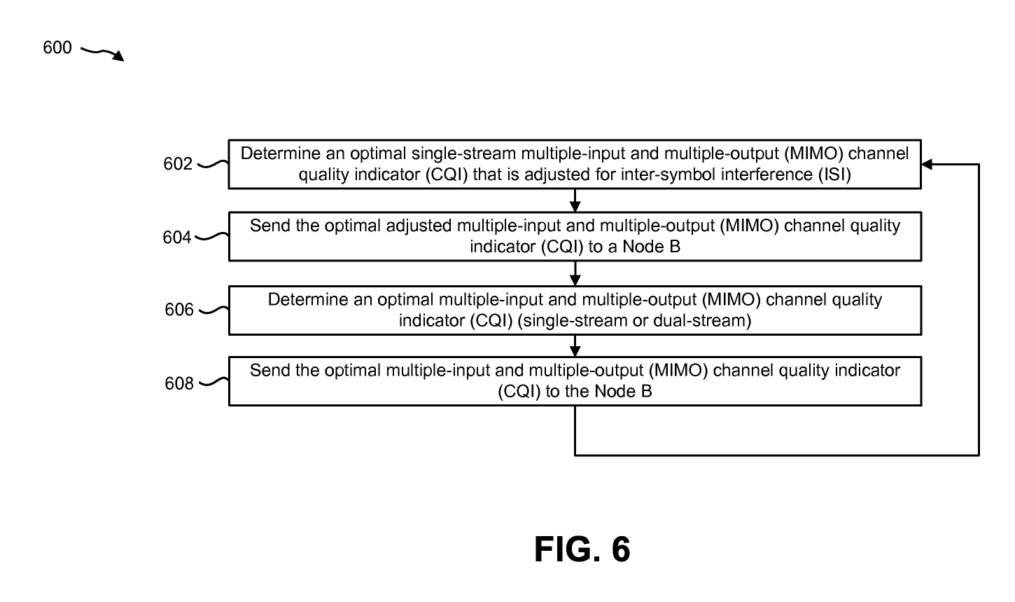

FIG. 6 is a flow diagram of a method 600 for sending channel quality indicator (CQI) 112 feedback that accounts for inter-stream interference (ISI). The method 600 may be performed by a user equipment (UE) 204. The user equipment (UE) 204 may be operating in a High-Speed Packet Access (HSPA) system. In the method 600 of FIG. 6, no standards changes are necessary for the base station 102 receiving the channel quality indicators (CQIs) 112.

The user equipment (UE) 204 may determine 602 an optimal single-stream multiple-input and multiple-output (MIMO) channel quality indicator (CQI) 112 that is adjusted for inter-stream interference (ISI). Whenever the user equipment (UE) 204 computes a channel quality indicator (CQI) 112 along a beam for multiple-user multiple-input and multiple-output (MU-MIMO), the user equipment (UE) 204 may assume 50% of the power on the beam that is orthogonal to it. This is enough to obtain a channel quality indicator (CQI) 112 that is adjusted for inter-stream interference (ISI).

There may be four possible single-stream channel quality indicators (CQIs) 112 to choose from. In some configurations of High-Speed Packet Access (HSPA), single-stream multiple-input and multiple-output (MIMO) channel quality indicators (CQIs) 112 may not account for inter-stream interference (ISI), leading to a base station 102 transmitting at an overly optimistic data rate 121 (i.e., a large transmit block size (TBS)) to the user equipment (UE) 204 if the base station 102 is using multiple-user multiple-input and multiple-output (MU-MIMO). The user equipment (UE) 204 may send 604 the optimal adjusted MIMO channel quality indicator (CQI) 112 to a Node B 202.

The user equipment (UE) 204 may then determine 606 an optimal multiple-input and multiple-output (MIMO) channel quality indicator (CQI) 112. The optimal multiple-input and multiple-output (MIMO) channel quality indicator (CQI) 112 may request either a single-stream or a dual-stream data transmission. The optimal multiple-input and multiple-output (MIMO) channel quality indicator (CQI) 112 may be a channel quality indicator (CQI) 112 that is generated according to Release 7. The decision between an optimal single-stream channel quality indicator (CQI) 112 and an optimal dual-stream channel quality indicator (CQI) 112 within a transmission time interval (TTI) 538 may be performed according to the High-Speed Packet Access protocol (e.g., Release 7).

There may be four possible single-stream channel quality indicators (CQIs) 112 and two possible dual-stream channel quality indicators (CQIs) 112. The user equipment (UE) 204 may calculate the optimal multiple-input and multiple-output (MIMO) channel quality indicator (CQI) 112 as the best of the six possible channel quality indicators (CQIs) 112. The optimal multiple-input and multiple-output (MIMO) channel quality indicator (CQI) 112 may refer to a regular channel quality indicator (CQI) 112 as it is fed back by the user equipment (UE) 204 to a Node B 202 according to Release 7. The user equipment (UE) 204 may send 608 the optimal multiple-input and multiple-output (MIMO) channel quality indicator (CQI) 112 to the Node B 202. The user equipment (UE) 204 may then return to determining 602 an optimal single-stream multiple-input and multiple-output (MIMO) channel quality indicator (CQI) 112 that is adjusted for inter-stream interference (ISI).

In general, user equipments (UEs) 204 with good geometry may report dual-stream channel quality indicators (CQIs) 112 more often than single-stream channel quality indicators (CQIs) 112. User equipments (UEs) 204 at the edge of a cell may report single-stream channel quality indicators (CQIs) 112 more often than dual-stream channel quality indicators (CQIs) 112.

Thus, the user equipment (UE) 204 may alternate between sending a channel quality indicator (CQI) 112 that is generated as in Release 7 and a channel quality indicator (CQI) 112 that is adjusted for inter-stream interference (ISI). In other words, the user equipment (UE) 204 may interlace optimal single-stream channel quality indicators (CQIs) 112 that are adjusted for inter-stream interference (ISI) in between the optimal multiple-input and multiple-output (MIMO) channel quality indicators (CQIs) 112 (that are generated as in Release 7). Depending on a feedback cycle used by the user equipment (UE) 204, the user equipment (UE) 204 may send one channel quality indicator (CQI) 112 for each transmission time interval (TTI) 538.

One advantage of using the user equipment (UE) 204 solution (i.e., the method 600 of FIG. 6) instead of the base station 102 solution (i.e., the method 300 of FIG. 3) is that better performance may be obtained. In every transmission time interval (TTI) 538, the base station 102 has access to a channel quality indicator (CQI) 112 for scheduling single-user multiple-input and multiple-output (SU-MIMO) transmissions and a channel quality indicator (CQI) 112 for scheduling multiple-user multiple-input and multiple-output (MU-MIMO) transmissions. The base station 102 may also use the best multiple-input and multiple-output (MIMO) channel quality indicator (CQI) 112 when scheduling single-user multiple-input and multiple-output (SU-MIMO) data transmissions. Each of these channel quality indicators (CQIs) 112 is outdated by at most one extra transmission time interval (TTI) 538 more than usual.

One consequence of using the user equipment (UE) 204 solution is that it may require changes to the channel quality indicator (CQI) 112 reporting protocol (e.g., the High-Speed Packet Access standards established by 3GPP). These changes may include implementing higher-layer messaging to configure the channel quality indicator (CQI) 112 feedback algorithm of the user equipment (UE) 204.

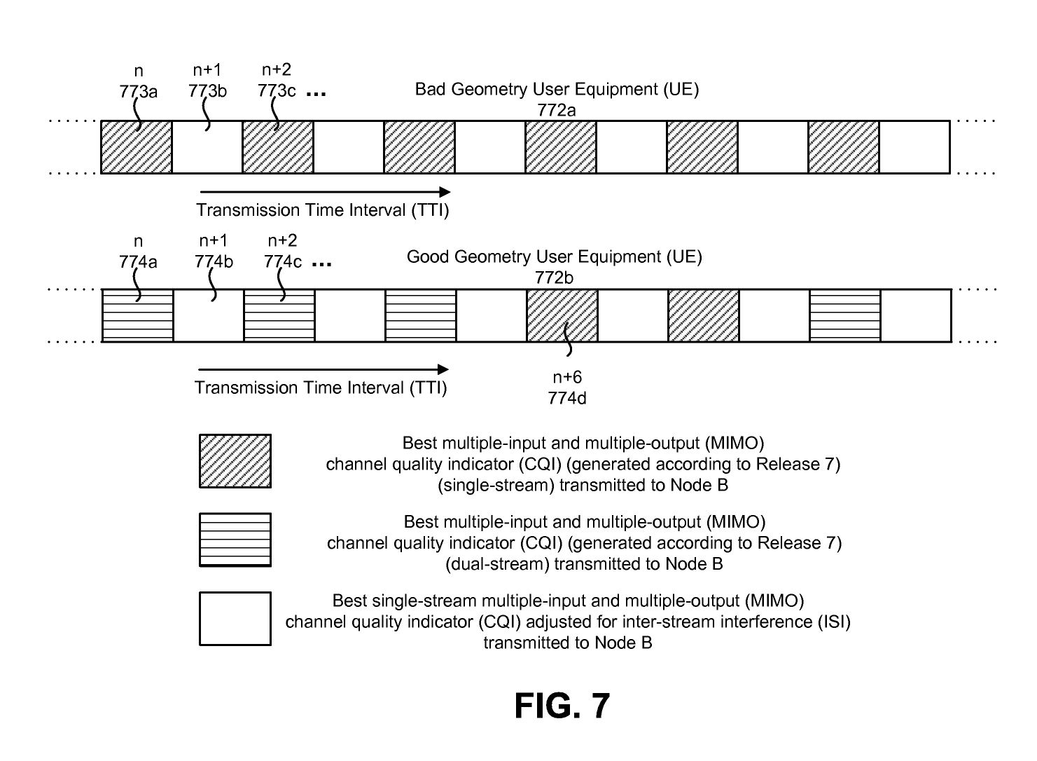

FIG. 7 is a timing diagram illustrating channel quality indicator (CQI) 112 feedback cycles for user equipments (UEs) 772a-b. FIG. 7 is a timing diagram for the method 600 illustrated in FIG. 6. Each box represents a channel quality indicator (CQI) 112 report for a given transmission time interval (TTI). As discussed above, a user equipment (UE) 772 may interlace optimal single-stream channel quality indicators (CQIs) 112 that are adjusted for inter-stream interference (ISI) in between the optimal multiple-input and multiple-output (MIMO) channel quality indicators (CQIs) 112 (referred to as an optimal Rel-7 channel quality indicator (CQI) 112).

The optimal Rel-7 channel quality indicator (CQI) 112 for a bad geometry user equipment (UE) 772a may often be a single-stream channel quality indicator (CQI) 112 such as that used in the transmission time interval (TTI) n 773a and in the transmission time interval (TTI) n+2 773c. In contrast, the optimal channel quality indicator (CQI) 112 for a good geometry user equipment (UE) 772b may often be a dual-stream channel quality indicator (CQI) 112 such as that used in the transmission time interval (TTI) n 774a and in the transmission time interval (TTI) n+2 774c. In one configuration (i.e., in the channel quality indicator (CQI) 112 of transmission time interval (TTI) n+6 774d), the optimal channel quality indicator (CQI) 112 for a good geometry user equipment (UE) 772b may instead be a single-stream channel quality indicator (CQI) 112.

The channel quality indicator (CQI) 112 reporting for either a bad geometry user equipment (UE) 772a or a good geometry user equipment (UE) 772b may be unchanged for every other transmission time interval (TTI) (e.g., n, n+2, n+4, etc.). In between these transmission time intervals (TTIs), both a bad geometry user equipment (UE) 772a and a good geometry user equipment (UE) 772b may determine and send an optimal single-stream channel quality indicator (CQI) 112 that has been adjusted for inter-stream interference (ISI) such as the channel quality indicator (CQI) 112 for the transmission time interval (TTI) n+1 773b for the bad geometry user equipment (UE) 772a and the channel quality indicator (CQI) 112 for the transmission time interval (TTI) n+1 774b for the good geometry user equipment (UE) 772b (e.g., for transmission time intervals (TTIs) n+1, n+3, n+5, etc.). FIG. 7 as illustrated is for a feedback cycle equal to 1. FIG. 7 may change accordingly for a feedback cycle that is greater than 1.

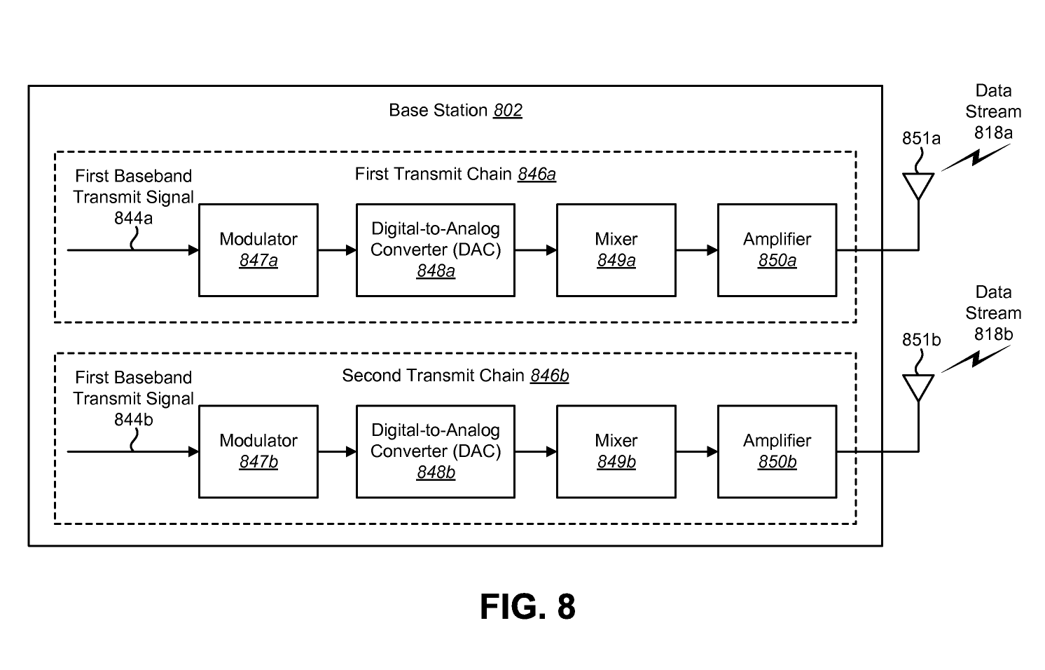

FIG. 8 is a block diagram of a base station 802 for use in the present systems and methods. The base station 802 of FIG. 8 may be one configuration of the base station 102 of FIG. 1. The base station 802 may include a first transmit chain 846a and a second transmit chain 846b. The first transmit chain 846a may be used for a first data stream 818a and the second transmit chain 846b may be used for a second data stream 818b.

The first transmit chain 846a may include a first baseband transmit signal 844a. The first baseband transmit signal 844a may be modulated using a modulator 847a, converted from a digital signal to an analog signal using a digital-to-analog converter (DAC) 848a, frequency converted using a mixer 849a, amplified using an amplifier 850a and finally transmitted by a first antenna 851a as the first data stream 818a. Likewise, the second transmit chain 846b may include a second baseband transmit signal 844b. The second baseband transmit signal 844b may be modulated using a modulator 847b, converted from a digital signal to an analog signal using a digital-to-analog converter (DAC) 848b, frequency converted using a mixer 849b, amplified using an amplifier 850b and finally transmitted by a second antenna 851b as the second data stream 818b. As discussed above, the first data stream 818a and the second data stream 818b may be transmitted during the same transmission time interval (TTI) 538 using the same orthogonal variable spreading factor (OVSF) codes 226 with orthogonal beams.

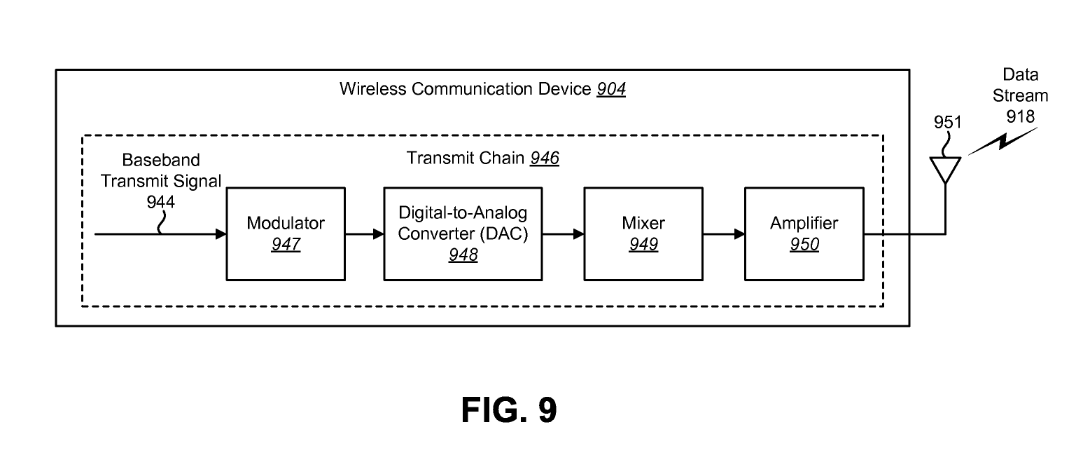

FIG. 9 is a block diagram of a wireless communication device 904 for use in the present systems and methods. The wireless communication device 904 of FIG. 9 may be one configuration of the wireless communication devices 104 of FIG. 1. The wireless communication device 904 may include a transmit chain 946. The transmit chain 946 may be used for a data stream 918.

The transmit chain 946 may include a baseband transmit signal 944. The baseband transmit signal 944 may be modulated using a modulator 947, converted from a digital signal to an analog signal using a digital-to-analog converter (DAC) 948, frequency converted using a mixer 949, amplified using an amplifier 950 and finally transmitted by an antenna 951 as the data stream 918. The data stream 918 may include one or more channel quality indicators (CQIs) sent by the wireless communication device 904 to a base station 102.

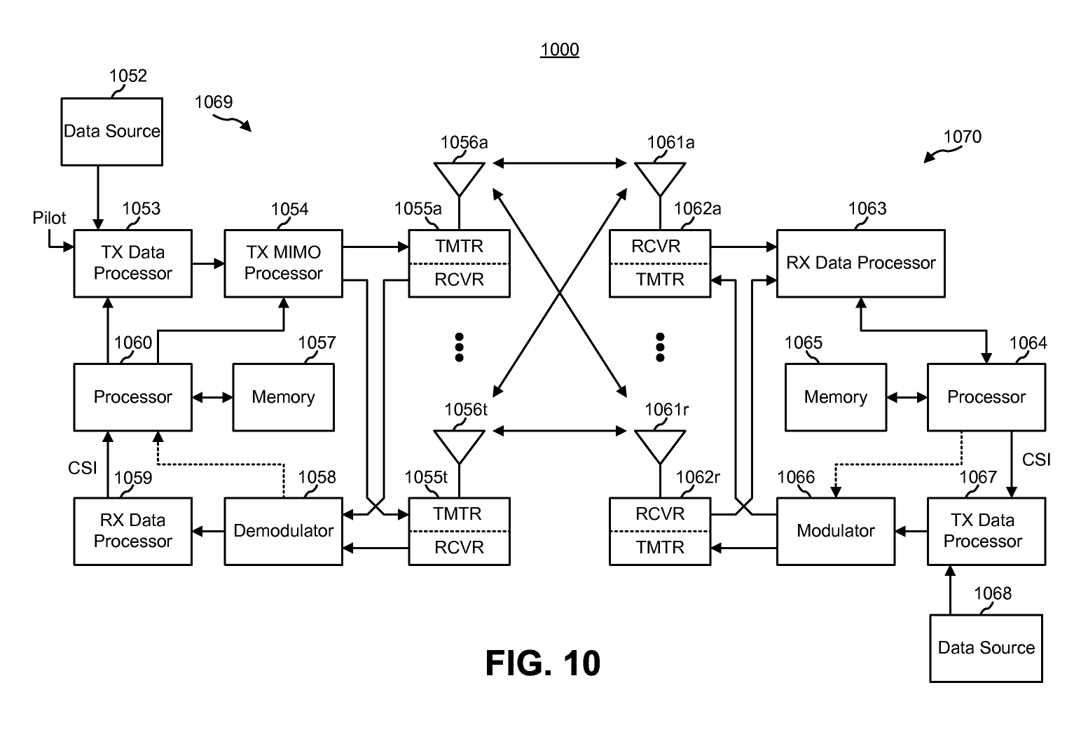

FIG. 10 is a block diagram of a transmitter 1069 and receiver 1070 in a multiple-input and multiple-output (MIMO) system 1000. In the transmitter 1069, traffic data for a number of data streams is provided from a data source 1052 to a transmit (TX) data processor 1053. Each data stream may then be transmitted over a respective transmit antenna 1056a through 1056t. The transmit (TX) data processor 1053 may format, code, and interleave the traffic data for each data stream based on a particular coding scheme selected for that data stream to provide coded data.

The coded data for each data stream may be multiplexed with pilot data using OFDM techniques. The pilot data may be a known data pattern that is processed in a known manner and used at the receiver 1070 to estimate the channel response. The multiplexed pilot and coded data for each stream is then modulated (i.e., symbol mapped) based on a particular modulation scheme (e.g., binary phase shift keying (BPSK), quadrature phase shift keying (QPSK), multiple phase shift keying (M-PSK) or multi-level quadrature amplitude modulation (M-QAM)) selected for that data stream to provide modulation symbols. The data rate, coding and modulation for each data stream may be determined by instructions performed by a processor.

The modulation symbols for all data streams may be provided to a transmit (TX) multiple-input multiple-output (MIMO) processor 1054, which may further process the modulation symbols (e.g., for OFDM). The transmit (TX) multiple-input multiple-output (MIMO) processor 1054 then provides NT modulation symbol streams to NT transmitters (TMTR) 1055a through 1055t. The TX transmit (TX) multiple-input multiple-output (MIMO) processor 1054 may apply beamforming weights to the symbols of the data streams and to the antenna 1056 from which the symbol is being transmitted.

Each transmitter 1055 may receive and process a respective symbol stream to provide one or more analog signals, and further condition (e.g., amplify, filter and upconvert) the analog signals to provide a modulated signal suitable for transmission over the MIMO channel. NT modulated signals from transmitters 1055a through 1055t are then transmitted from NT antennas 1056a through 1056t, respectively.

At the receiver 1070, the transmitted modulated signals are received by NR antennas 1061a through 1061r and the received signal from each antenna 1061 is provided to a respective receiver (RCVR) 1062a through 1062r. Each receiver 1062 may condition (e.g., filter, amplify and downconvert) a respective received signal, digitize the conditioned signal to provide samples, and further process the samples to provide a corresponding “received” symbol stream.

An RX data processor 1063 then receives and processes the NR received symbol streams from NR receivers 1062 based on a particular receiver processing technique to provide NT “detected” symbol streams. The RX data processor 1063 then demodulates, deinterleaves and decodes each detected symbol stream to recover the traffic data for the data stream. The processing by RX data processor 1063 is complementary to that performed by TX MIMO processor 1054 and TX data processor 1053 at transmitter system 1069.

A processor 1064 may periodically determine which pre-coding matrix to use. The processor 1064 may store information on and retrieve information from memory 1065. The processor 1064 formulates a reverse link message comprising a matrix index portion and a rank value portion. The reverse link message may be referred to as channel state information (CSI). The reverse link message may comprise various types of information regarding the communication link and/or the received data stream. The reverse link message is then processed by a TX data processor 1067, which also receives traffic data for a number of data streams from a data source 1068, modulated by a modulator 1066, conditioned by transmitters 1062a through 1062r, and transmitted back to the transmitter 1069.

At the transmitter 1069, the modulated signals from the receiver are received by antennas 1056, conditioned by receivers 1055, demodulated by a demodulator 1058, and processed by an RX data processor 1059 to extract the reverse link message transmitted by the receiver system 1070. A processor 1060 may receive channel state information (CSI) from the RX data processor 1059. The processor 1060 may store information on and retrieve information from memory 1057. The processor 1060 then determines which pre-coding matrix to use for determining the beamforming weights and then processes the extracted message.

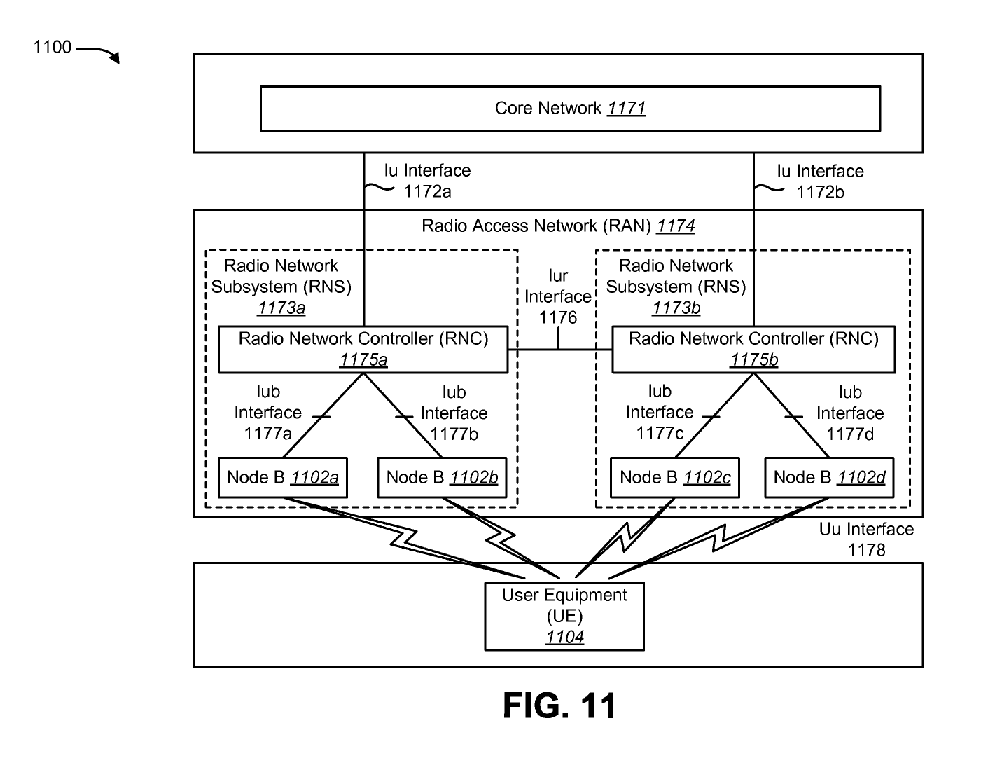

FIG. 11 is a block diagram illustrating a radio network 1100 operating according to Universal Mobile Telecommunications System (UMTS) standards. The radio network 1100 may be a UMTS Terrestrial Radio Access Network (UTRAN). A UMTS Terrestrial Radio Access Network (UTRAN) is a collective term for the Node Bs 1102a-d and the control equipment for the Node Bs 1102a-d (or radio network controllers (RNCs) 1175a) it contains which make up the UMTS radio access network (RAN) 1174. This is a 3 G communications network which can carry both real-time circuit switched and IP based packet switched traffic types. The UTRAN provides an air interface access method for the user equipment (UE) 1104. Connectivity is provided between the user equipment (UE) 1104 and the core network 1171 by the UTRAN. The radio access network (RAN) 1174 may transport data packets between multiple user equipments (UEs) 1104.

The UTRAN is connected internally or externally to other functional entities by four interfaces: the Iu interface 1172a-b, the Uu interface 1178, the Iub interface 1177a-d and the Iur interface 1176. The UTRAN is attached to a Global Systems for Mobile (GSM) core network 1171 via an external interface called Iu interface 1172. The radio network controllers (RNCs) 1175a-b support this interface. In addition, the radio network controllers (RNCs) 1175a-b manage a set of base stations called Node Bs 1102a-d through interfaces labeled Iub interface 1177a-d. A radio network controller (RNC) 1175 and the managed Node Bs 1102 form a radio network subsystem (RNS) 1173a-b. The Iur interface 1176 connects a first radio network controller (RNC) 1175a and a second radio network controller (RNC) 1175b with each other. The UTRAN is largely autonomous from the core network 1171 since the radio network controllers (RNCs) 1175a-b are interconnected by the Iur interface 1176. FIG. 11 discloses a communication system which uses the radio network controller (RNC) 1175, the Node Bs 1102a-d, the Iub interface 1172 and the Uu interface 1178. The Uu interface 1178 is also external and connects the Node B 1102 with the user equipment (UE) 1104, while the Iub interface 1177 is an internal interface connecting the radio network controller (RNC) 1175 with the Node B 1102.

The radio network 1100 may be further connected to additional networks outside the radio network 1100, such as a corporate intranet, the Internet, or a conventional public switched telephone network as stated above, and may transport data packets between each user equipment (UE) 1104 and such outside networks.

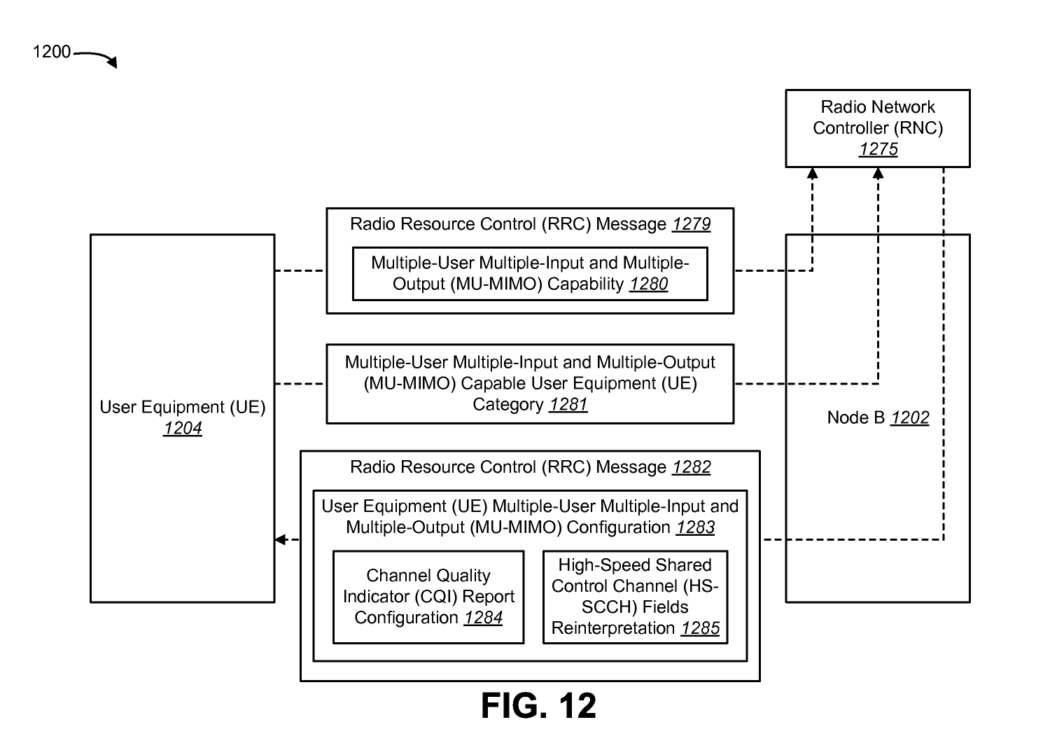

FIG. 12 is a block diagram illustrating communications between a user equipment (UE) 1204, a Node B 1202 and a radio network controller (RNC) 1275 in a wireless communications network 1200. The user equipment (UE) 1204 of FIG. 12 may be one configuration of the user equipment (UE) 204 of FIG. 2. The Node B 1202 of FIG. 12 may be one configuration of the Node B 202 of FIG. 2. The radio network controller (RNC) 1275 of FIG. 12 may be one configuration of the radio network controller (RNC) 1175 of FIG. 11. The wireless communications network 1200 may operate using High-Speed Packet Access (HSPA). Both the Node B 1202 and the user equipment (UE) 1204 may be capable of multiple-user multiple-input and multiple-output (MU-MIMO) operations. The user equipment (UE) 1204 and the radio network controller (RNC) 1275 may communicate with each other via the Node B 1202 using Layer 3 messages. Layer 3 messages may also be referred to as radio resource control (RRC) messages. Layer 3 messages may be passed between the UTRAN and the user equipment (UE) 1204 and are used to configure and control the radio resource control (RRC) connection between a user equipment (UE) 1204 and the UTRAN. Layer 3 messages may deal with connection management, control, mobility and measurement messages.

As discussed above, the Node B 1202 may communicate with the user equipment (UE) 1204 via the Uu interface 1178. The Node B 1202 may communicate with the radio network controller (RNC) 1275 via the Iub interface 1177. The Node B 1202, the radio network controller (RNC) 1275 and the user equipment (UE) 1204 may all operate in accordance with a standard. Small changes to the standard may be needed to accommodate some signaling possibilities associated with multiple-user multiple-input and multiple-output (MU-MIMO) operation. As standards changes may be involved, multiple-user multiple-input and multiple-output (MU-MIMO) operation may be automatically detectable.

The user equipment (UE) 1204 may indicate to the radio network controller (RNC) 1275 that it is multiple-user multiple-input and multiple-output (MU-MIMO) capable. In one configuration, the user equipment (UE) 1204 may send a Radio Resource Control (RRC) message 1279 to the radio network controller (RNC) 1275 via the Node B 1202. The Radio Resource Control (RRC) message 1279 may indicate the multiple-user multiple-input and multiple-output (MU-MIMO) capabilities 1280 of the user equipment (UE) 1204. In another configuration, the user equipment (UE) 1204 may send a message to the radio network controller (RNC) 1275 via the Node B 1202 indicating that the user equipment (UE) 1204 is within a designated multiple-user multiple-input and multiple-output (MU-MIMO) capable category 1281. In other words, the user equipment (UE) 1204 may indicate that it is in a category that is defined as being multiple-user multiple-input and multiple-output (MU-MIMO) capable.

The radio network controller (RNC) 1275 may send configuration messages to the user equipment (UE) 1204 via the Node B 1202. For example, the radio network controller (RNC) 1275 may send a Radio Resource Control (RRC) message 1282 to the user equipment (UE) 1204 via the Node B 1202. The Radio Resource Control (RRC) message 1282 may include a user equipment (UE) multiple-user multiple-input and multiple-output (MU-MIMO) configuration 1283 for the user equipment (UE) 1204. The user equipment (UE) multiple-user multiple-input and multiple-output (MU-MIMO) configuration 1283 may be required for the user equipment (UE) 1204 to support multiple-user multiple-input and multiple-output (MU-MIMO) operation.

The user equipment (UE) multiple-user multiple-input and multiple-output (MU-MIMO) configuration 1283 may include a channel quality indicator (CQI) report configuration 1284. The channel quality indicator (CQI) report configuration 1284 may make changes to channel quality indicator (CQI) reporting by the user equipment (UE) 1204 (such as those discussed above in relation to FIG. 6). The user equipment (UE) multiple-user multiple-input and multiple-output (MU-MIMO) configuration 1283 may also include a high-speed shared control channel (HS-SCCH) fields reinterpretation 1285. The high-speed shared control channel (HS-SCCH) fields reinterpretation 1285 may instruct the user equipment (UE) 1204 on how to interpret high-speed shared control channel (HS-SCCH) fields differently than they would be interpreted otherwise. The user equipment (UE) 1204 may use the information in the Radio Resource Control (RRC) message 1282 to adjust configurations for multiple-user multiple-input and multiple-output (MU-MIMO) operation.

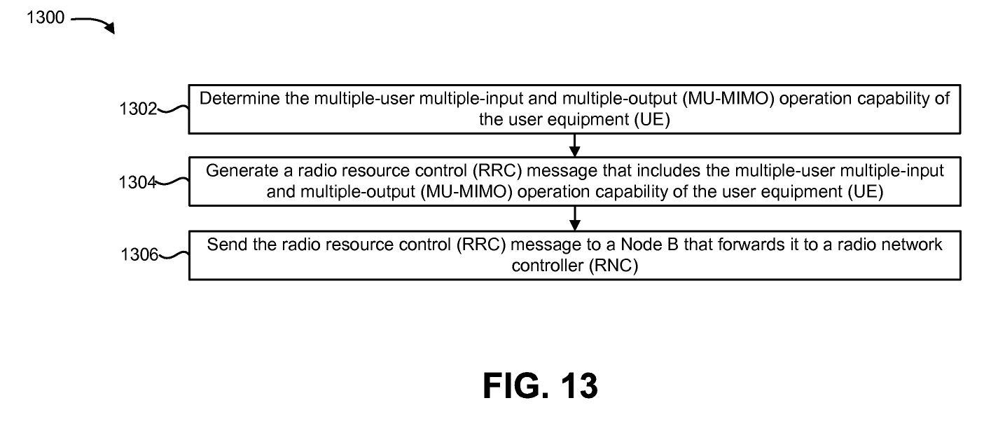

FIG. 13 is a flow diagram of a method 1300 for signaling a user equipment's (UE's) multiple-user multiple-input and multiple-output (MU-MIMO) operation capability 1280 from a user equipment (UE) 1204 to a radio network controller (RNC) 1275. The method 1300 may be performed by a user equipment (UE) 1204. The user equipment (UE) 1204 may determine 1302 the multiple-user multiple-input and multiple-output (MU-MIMO) operation capability 1280 of the user equipment (UE) 1204. Examples of multiple-user multiple-input and multiple-output (MU-MIMO) operation capabilities 1280 of the user equipment (UE) 1204 include the ability to configure multiple-user multiple-input and multiple-output (MU-MIMO) channel quality indicator (CQI) 112 feedback if asked to do so by the radio network controller (RNC) 1175 and the ability to reinterpret fields in the high-speed shared control channel (HS-SCCH) if asked to do so by the radio network controller (RNC) 1175. These operations may be required of the multiple-user multiple-input and multiple-output (MU-MIMO) user equipment (UE) 1204.

The user equipment (UE) 1204 may generate 1304 a Radio Resource Control (RRC) message 1279 that includes the multiple-user multiple-input and multiple-output (MU-MIMO) operation capability 1280 of the user equipment (UE) 1204. The user equipment (UE) 1204 may then send 1306 the Radio Resource Control (RRC) message 1279 to a Node B 1202 that forwards it to a radio network controller (RNC) 1275.

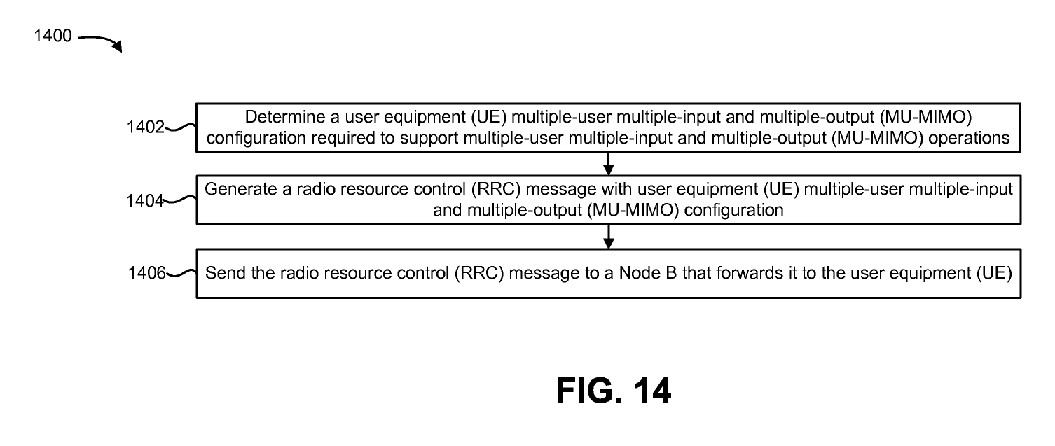

FIG. 14 is a flow diagram of a method 1400 for signaling a user equipment (UE) multiple-user multiple-input and multiple-output (MU-MIMO) configuration 1283 required to support multiple-user multiple-input and multiple-output (MU-MIMO) operations from a network to a user equipment (UE) 1204. The method 1400 may be performed by a radio network controller (RNC) 1275. The radio network controller (RNC) 1275 may determine 1402 a user equipment (UE) multiple-user multiple-input and multiple-output (MU-MIMO) configuration 1283 required to support multiple-user multiple-input and multiple-output (MU-MIMO) operations. The radio network controller (RNC) 1275 may then generate 1404 a Radio Resource Control (RRC) message 1282 that includes the user equipment (UE) multiple-user multiple-input and multiple-output (MU-MIMO) configuration 1283. The radio network controller (RNC) 1275 may send 1406 the Radio Resource Control (RRC) message 1282 to a Node B 1202 that forwards it to the user equipment (UE) 1204. As discussed above in relation to FIG. 12, the Radio Resource Control (RRC) message 1282 may also include the channel quality indicator (CQI) report configuration 1284 changes for the user equipment (UE) and high-speed shared control channel (HS-SCCH) fields reinterpretation 1285 changes for the user equipment (UE) 1204.

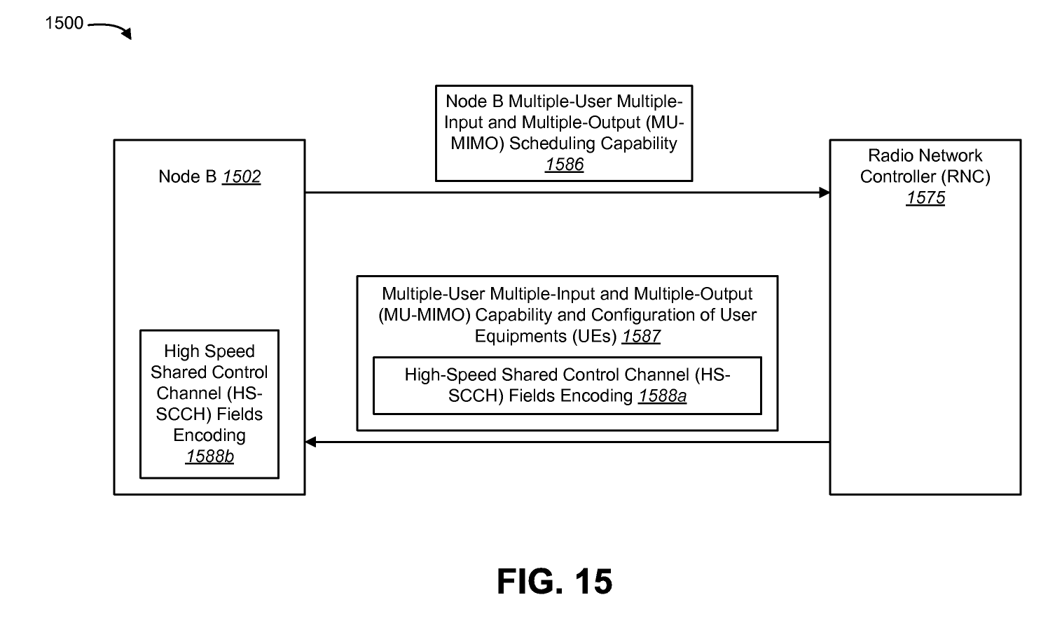

FIG. 15 is a block diagram illustrating communications between a Node B 1502 and a radio network controller (RNC) 1575 in a wireless communications network 1500. The Node B 1502 of FIG. 15 may be one configuration of the Node B 202 of FIG. 2. The radio network controller (RNC) 1575 of FIG. 15 may be one configuration of the radio network controller (RNC) 1175 of FIG. 11. The wireless communications network 1500 may operate using High-Speed Packet Access (HSPA). The Node B 1502 may be capable of multiple-user multiple-input and multiple-output (MU-MIMO) operations. Communications between a Node B 1502 and a radio network controller (RNC) 1575 may take place over the Iub interface 1177 (i.e., layer).

The Node B 1502 may send a message to the radio network controller (RNC) 1575 that indicates the Node B multiple-user multiple-input and multiple-output (MU-MIMO) scheduling capabilities 1586. For example, the message may indicate that the Node B 1502 is capable of scheduling a multiple-user multiple-input and multiple-output (MU-MIMO) packet.

The radio network controller (RNC) 1575 may have information regarding the user equipments (UEs) 1104 being served by the Node B 1502. For example, the radio network controller (RNC) 1575 may know the multiple-user multiple-input and multiple-output (MU-MIMO) capability and configuration of each user equipment (UE) 1587 being served by the Node B 1502. The radio network controller (RNC) 1575 may send the multiple-user multiple-input and multiple-output (MU-MIMO) capability and configuration of the user equipments (UEs) 1587 to the Node B 1502 in a message. In one configuration, the message may also indicate that the high-speed shared control channel (HS-SCCH) fields encoding 1588a-b will need to be changed at the Node B 1502 (since some of the fields in the high-speed shared control channel (HS-SCCH) may be interpreted differently by a user equipment (UE)) 1104.

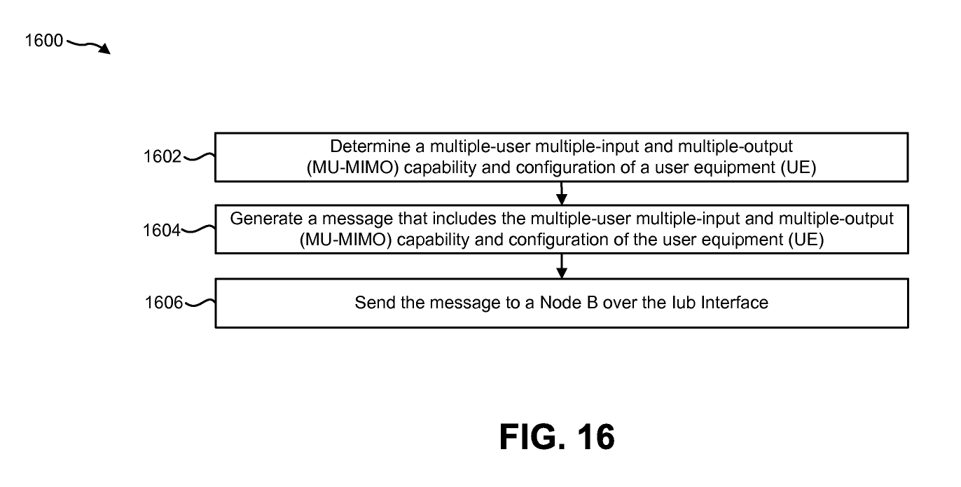

FIG. 16 is a flow diagram of a method 1600 for signaling the multiple-user multiple-input and multiple-output (MU-MIMO) capability and configuration of a user equipment (UE) 1587 from a radio network controller (RNC) 1575 to a Node B 1502. The method 1600 may be performed by a radio network controller (RNC) 1575. Communications between the radio network controller (RNC) 1575 and the Node B 1502 may be over the Iub interface 1177.

The radio network controller (RNC) 1575 may determine 1602 a multiple-user multiple-input and multiple-output (MU-MIMO) capability and configuration of a user equipment (UE) 1587. In one configuration, the radio network controller (RNC) 1575 may determine the multiple-user multiple-input and multiple-output (MU-MIMO) capabilities and configurations of multiple user equipments (UEs) 1587. The radio network controller (RNC) 1575 may generate 1604 a message that includes the multiple-user multiple-input and multiple-output (MU-MIMO) capability and configuration of the user equipment (UE) 1587. The radio network controller (RNC) 1575 may then send 1606 the message to a Node B 1502 over the Iub interface 1177.

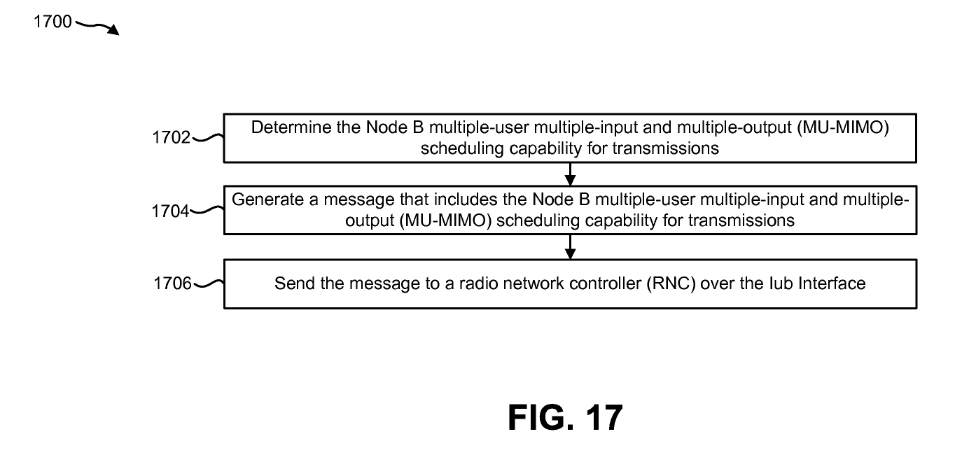

FIG. 17 is a flow diagram of a method 1700 for signaling a Node B multiple-user multiple-input and multiple-output (MU-MIMO) scheduling capability 1586 to a radio network controller (RNC) 1575. The method 1700 may be performed by a Node B 1502. Communications between the Node B 1502 and the radio network controller (RNC) 1575 may be over the Iub interface 1177.

The Node B 1502 may determine 1702 the Node B multiple-user multiple-input and multiple-output (MU-MIMO) scheduling capability 1586 for transmissions. For example, the Node B 1502 may determine how often multiple-user multiple-input and multiple-output (MU-MIMO) transmissions can be scheduled, the power available for multiple-user multiple-input and multiple-output (MU-MIMO) transmissions and the current load of the Node B 1502. The Node B 1502 may then generate 1704 a message that includes the Node B multiple-user multiple-input and multiple-output (MU-MIMO) scheduling capability 1586 for transmissions. The Node B 1502 may send 1706 the message to a radio network controller (RNC) 1575 over the Iub interface 1177.

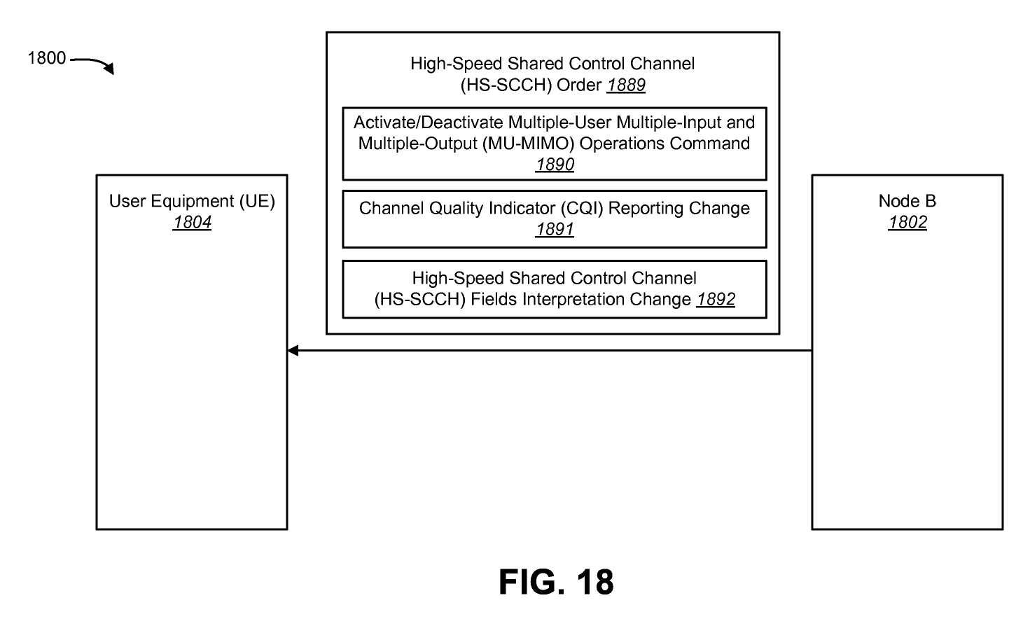

FIG. 18 is a block diagram illustrating the transmission of a high-speed shared control channel (HS-SCCH) order 1889 from a Node B 1802 to a user equipment (UE) 1804 in a wireless communications network 1800. The user equipment (UE) 1804 of FIG. 18 may be one configuration of the user equipment (UE) 204 of FIG. 2. The Node B 1802 of FIG. 18 may be one configuration of the Node B 202 of FIG. 2. The wireless communications network 1800 may operate using High-Speed Packet Access (HSPA). Both the Node B 1802 and the user equipment (UE) 1804 may be capable of multiple-user multiple-input and multiple-output (MU-MIMO) operations. The high-speed shared control channel (HS-SCCH) is a downlink physical channel used to carry downlink signaling information related to a high-speed downlink shared channel (HS-DSCH) transmission. A Node B 1802 may use a high-speed shared control channel (HS-SCCH) order 1889 to activate/deactivate the uplink discontinuous transmission (UL-DTX) and/or the downlink discontinuous receiving (DL-DRX) by sending them as L1/PHY signaling commands to the user equipment (UE) 1804.

The high-speed shared control channel (HS-SCCH) order 1889 may include an activate/deactivate multiple-user multiple-input and multiple-output (MU-MIMO) command 1890. The activate/deactivate multiple-user multiple-input and multiple-output (MU-MIMO) command 1890 may activate or deactivate multiple-user multiple-input and multiple-output (MU-MIMO) operations at the user equipment (UE) 1804. There may be instances when multiple-user multiple-input and multiple-output (MU-MIMO) operation is not highly beneficial (e.g., only two user equipments (UEs) 1804 are being served). There may also be instances when multiple-user multiple-input and multiple-output (MU-MIMO) operation would be particularly beneficial (e.g., multiple user equipments (UEs) 1804 requesting large amounts of traffic).

The high-speed shared control channel (HS-SCCH) order 1889 may also include a channel quality indicator (CQI) reporting change 1891. The user equipment (UE) 1804 may thus be instructed on changes to channel quality indicator (CQI) reporting. The high-speed shared control channel (HS-SCCH) order 1889 may further include a high-speed shared control channel (HS-SCCH) fields interpretation change 1892. Upon receiving the high-speed shared control channel (HS-SCCH) order 1889, the user equipment (UE) 1804 may activate/deactivate multiple-user multiple-input and multiple-output (MU-MIMO) operations, apply the channel quality indicator (CQI) reporting change 1891 and/or apply the high-speed shared control channel (HS-SCCH) fields interpretation change 1892.

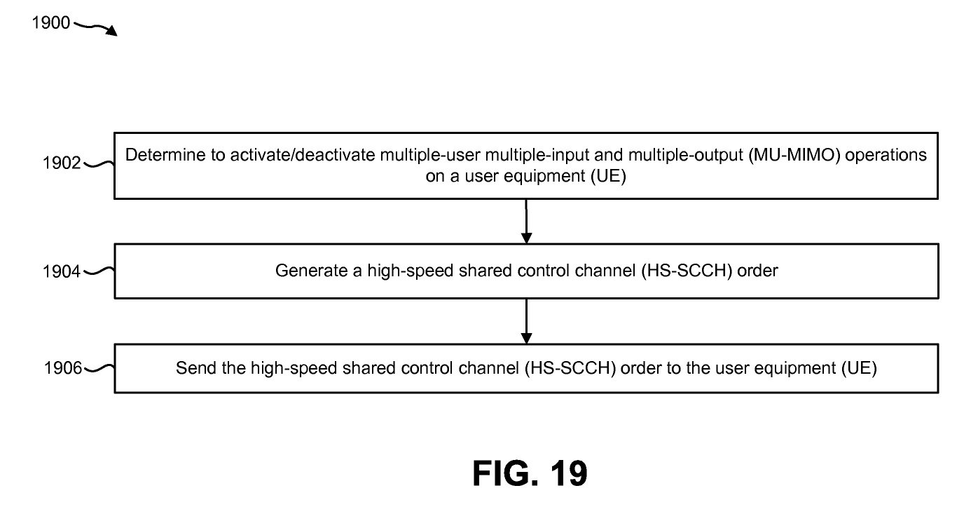

FIG. 19 is a flow diagram of a method 1900 for sending a high-speed shared control channel (HS-SCCH) order 1889 to a user equipment (UE) 1804. The method 1900 may be performed by a Node B 1802. The Node B 1802 may determine 1902 to activate/deactivate multiple-user multiple-input and multiple-output (MU-MIMO) operations on a user equipment (UE) 1804. In one configuration, the Node B 1802 may further determine to change the channel quality indicator (CQI) reporting configurations of the user equipment (UE) 1804. In yet another configuration, the Node B 1802 may determine to change the high-speed shared control channel (HS-SCCH) fields interpretation of the user equipment (UE) 1804.

The Node B 1802 may then generate 1904 a high-speed shared control channel (HS-SCCH) order 1889. As discussed above, the high-speed shared control channel (HS-SCCH) order 1889 may include an activation/deactivation of multiple-user multiple-input and multiple-output (MU-MIMO) operations command 1890, a channel quality indicator (CQI) reporting change 1891 and/or a high-speed shared control channel (HS-SCCH) fields interpretation change 1892. The Node B 1802 may then send 1906 the high-speed shared control channel (HS-SCCH) order 1889 to the user equipment (UE) 1804.

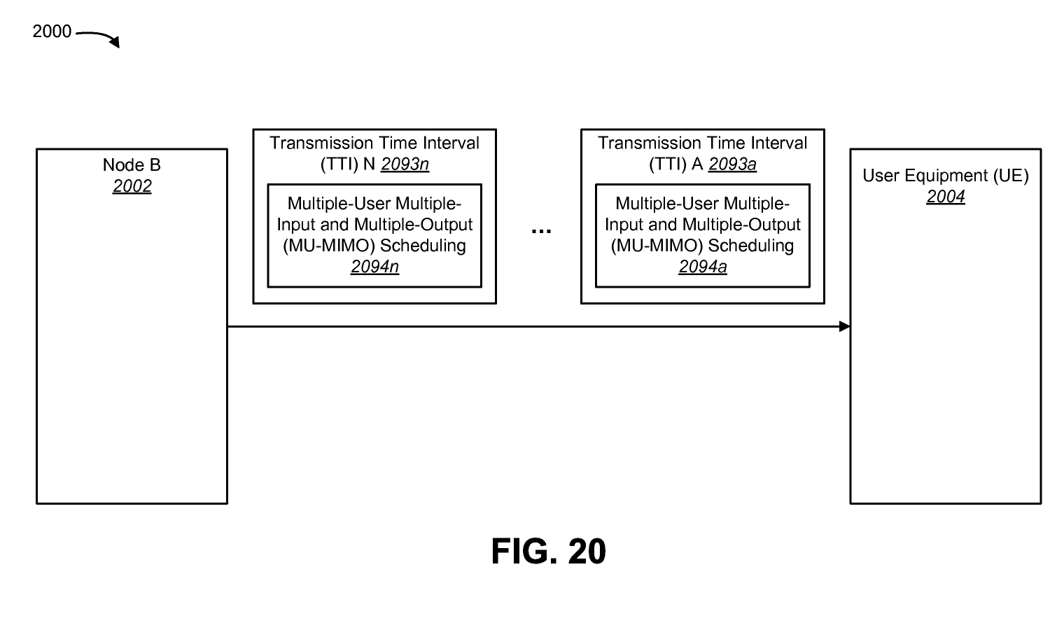

FIG. 20 is a block diagram illustrating multiple-user multiple-input and multiple-output (MU-MIMO) scheduling 2094a-n transmitted from a Node B 2002 to a user equipment (UE) 2004 for every transmission time interval (TTI) 2093a-n in a wireless communications network 2000. The user equipment (UE) 2004 of FIG. 20 may be one configuration of the user equipment (UE) 204 of FIG. 2. The Node B 2002 of FIG. 20 may be one configuration of the Node B 202 of FIG. 2. The wireless communications network 2000 may operate using High-Speed Packet Access (HSPA). Both the Node B 2002 and the user equipment (UE) 2004 may be capable of multiple-user multiple-input and multiple-output (MU-MIMO) operations. A Node B 2002 may signal a user equipment (UE) 2004 regarding multiple-user multiple-input and multiple-output (MU-MIMO) scheduling 2094. This signaling may be “long-term,” where the signaling does not occur every transmission time interval (TTI) 2093. For example, certain user equipments (UEs) 2004 do not need such signaling for each transmission time interval (TTI) 2093.

However, there may be cases where a user equipment (UE) 2004 needs multiple-user multiple-input and multiple-output (MU-MIMO) scheduling 2094 for each transmission time interval (TTI) 2093. For example, a Node B 2002 may send multiple-user multiple-input and multiple-output (MU-MIMO) scheduling 2094 information (e.g., whether or not multiple-user multiple-input and multiple-output (MU-MIMO) transmissions are being used in a particular transmission time interval (TTI) 2093) to a user equipment (UE) 2004 during each transmission time interval (TTI) 2093. This may be accomplished in several ways. In a first option, a high-speed shared control channel (HS-SCCH) may be configured on a common High Speed Downlink Shared Channel—Radio Network Temporary Identifier (H-RNTI). The common High Speed Downlink Shared Channel—Radio Network Temporary Identifier (H-RNTI) may be decoded by all of the user equipments (UEs) 2004 in a cell. Thus, the multiple-user multiple-input and multiple-output (MU-MIMO) scheduling 2094 information may be sent via a high-speed shared control channel (HS-SCCH) on a common High Speed Downlink Shared Channel—Radio Network Temporary Identifier (H-RNTI).

In a second option, the Node B 2002 may signal multiple-user multiple-input and multiple-output (MU-MIMO) transmission through certain fields of the high-speed shared control channel (HS-SCCH). For example, certain bits of the channelization code set could be used for this purpose. The user equipment (UE) 2004 may re-interpret the bits (which would otherwise be interpreted differently) to mean that multiple-user multiple-input and multiple-output (MU-MIMO) scheduling is happening for this particular transmission time interval (TTI) 2093. On the other hand, the Node B 2002 could set the secondary transport block size field of the high-speed shared control channel (HS-SCCH) to 111111 and the corresponding redundancy version field could be set to 0. Again, the user equipment (UE) 2004 may re-interpret the bits (which would otherwise be interpreted differently) to mean an indication of multiple-user multiple-input and multiple-output (MU-MIMO) transmission in this particular transmission time interval (TTI) 2093.

When a user equipment (UE) 2004 is Release-7 capable or Transmit Antenna Array (TxAA) capable, other options may be used for multiple-user multiple-input and multiple-output (MU-MIMO) scheduling 2094. One option (when the user equipment (UE) 2004 is Release-7 or TxAA capable) is for the Node B 2002 to use a typically unused combination of a modulation scheme and a number of transport blocks in a high-speed shared control channel (HS-SCCH) to convey multiple-user multiple-input and multiple-output (MU-MIMO) scheduling 2094 to the user equipment (UE) 2004 for each transmission time interval (TTI) 2093. For a user equipment (UE) 2004 that is Transmit Antenna Array (TxAA) capable, the Node B 2002 may use one bit of a Hybrid Automatic Repeat Request (HARD) processing identification (ID) in a high-speed shared control channel (HS-SCCH) to convey the multiple-user multiple-input and multiple-output (MU-MIMO) scheduling 2094 information to a user equipment (UE) 2004 for each transmission time interval (TTI) 2093.

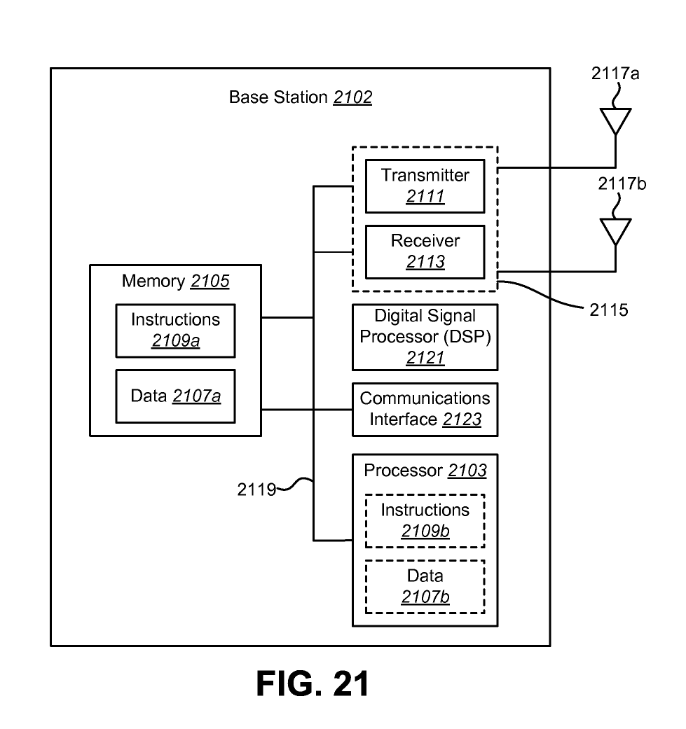

FIG. 21 illustrates certain components that may be included within a base station 2102. A base station may also be referred to as, and may include some or all of the functionality of, an access point, a broadcast transmitter, a NodeB, an evolved NodeB, etc. The base station 2102 includes a processor 2103. The processor 2103 may be a general purpose single- or multi-chip microprocessor (e.g., an ARM), a special purpose microprocessor (e.g., a digital signal processor (DSP)), a microcontroller, a programmable gate array, etc. The processor 2103 may be referred to as a central processing unit (CPU). Although just a single processor 2103 is shown in the base station 2102 of FIG. 21, in an alternative configuration, a combination of processors (e.g., an ARM and DSP) could be used.

The base station 2102 also includes memory 2105. The memory 2105 may be any electronic component capable of storing electronic information. The memory 2105 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 2107a and instructions 2109a may be stored in the memory 2105. The instructions 2109a may be executable by the processor 2103 to implement the methods disclosed herein. Executing the instructions 2109a may involve the use of the data 2107a that is stored in the memory 2105. When the processor 2103 executes the instructions 2109a, various portions of the instructions 2109b may be loaded onto the processor 2103, and various pieces of data 2107b may be loaded onto the processor 2103.

The base station 2102 may also include a transmitter 2111 and a receiver 2113 to allow transmission and reception of signals to and from the base station 2102. The transmitter 2111 and receiver 2113 may be collectively referred to as a transceiver 2115. Multiple antennas 2117a-b may be electrically coupled to the transceiver 2115. The base station 2102 may also include (not shown) multiple transmitters, multiple receivers, multiple transceivers and/or additional antennas.

The base station 2102 may include a digital signal processor (DSP) 2121. The base station 2102 may also include a communications interface 2123. The communications interface 2123 may allow a user to interact with the base station 2102.

The various components of the base station 2102 may be coupled together by one or more buses, which may include a power bus, a control signal bus, a status signal bus, a data bus, etc. For the sake of clarity, the various buses are illustrated in FIG. 21 as a bus system 2119.

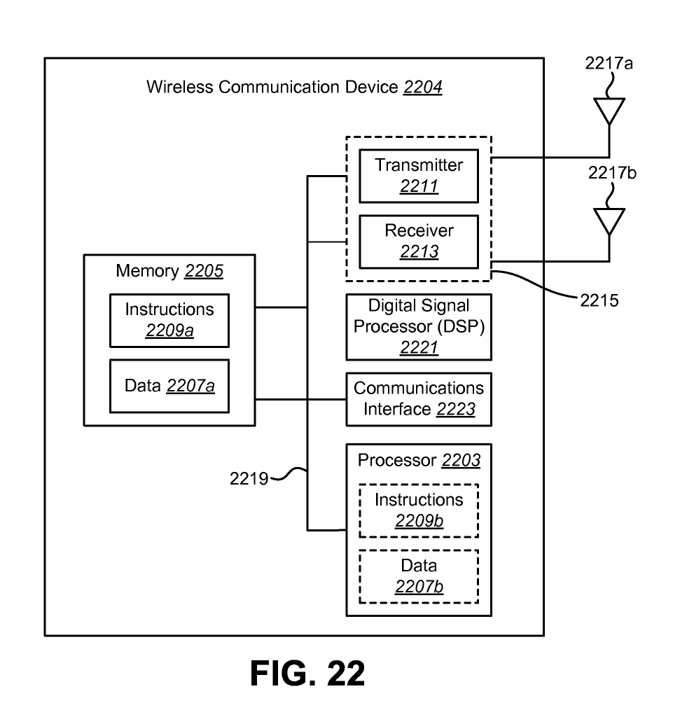

FIG. 22 illustrates certain components that may be included within a wireless communication device 2204. The wireless communication device 2204 may be an access terminal, a mobile station, a user equipment (UE), etc. The wireless communication device 2204 includes a processor 2203. The processor 2203 may be a general purpose single- or multi-chip microprocessor (e.g., an ARM), a special purpose microprocessor (e.g., a digital signal processor (DSP)), a microcontroller, a programmable gate array, etc. The processor 2203 may be referred to as a central processing unit (CPU). Although just a single processor 2203 is shown in the wireless communication device 2204 of FIG. 22, in an alternative configuration, a combination of processors (e.g., an ARM and DSP) could be used.

The wireless communication device 2204 also includes memory 2205. The memory 2205 may be any electronic component capable of storing electronic information. The memory 2205 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 2207a and instructions 2209a may be stored in the memory 2205. The instructions 2209a may be executable by the processor 2203 to implement the methods disclosed herein. Executing the instructions 2209a may involve the use of the data 2207a that is stored in the memory 2205. When the processor 2203 executes the instructions 2209a, various portions of the instructions 2209b may be loaded onto the processor 2203, and various pieces of data 2207b may be loaded onto the processor 2203.

The wireless communication device 2204 may also include a transmitter 2211 and a receiver 2213 to allow transmission and reception of signals to and from the wireless communication device 2204. The transmitter 2211 and receiver 2213 may be collectively referred to as a transceiver 2215. Multiple antennas 2217a-b may be electrically coupled to the transceiver 2215. The wireless communication device 2204 may also include (not shown) multiple transmitters, multiple receivers, multiple transceivers and/or additional antennas.

The wireless communication device 2204 may include a digital signal processor (DSP) 2221. The wireless communication device 2204 may also include a communications interface 2223. The communications interface 2223 may allow a user to interact with the wireless communication device 2204.

The various components of the wireless communication device 2204 may be coupled together by one or more buses, which may include a power bus, a control signal bus, a status signal bus, a data bus, etc. For the sake of clarity, the various buses are illustrated in FIG. 22 as a bus system 2219.

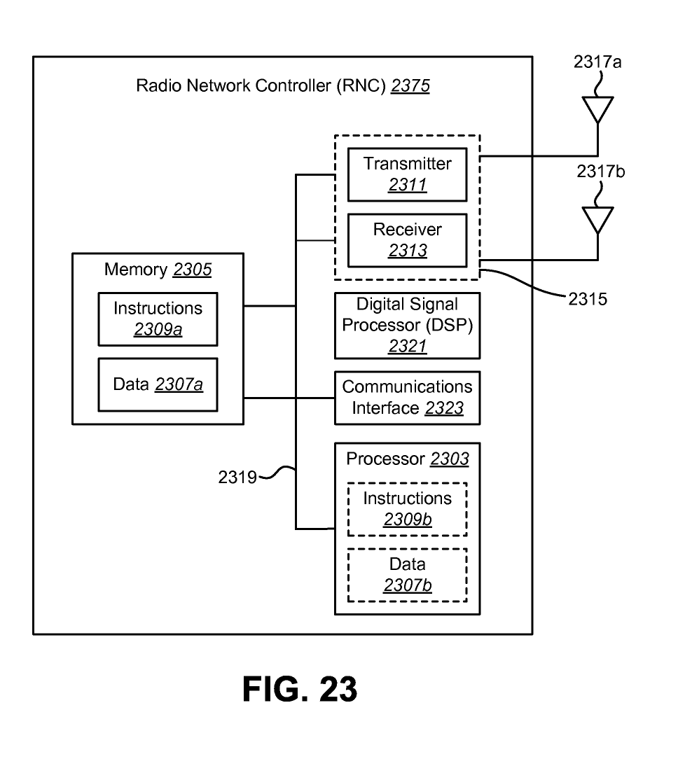

FIG. 23 illustrates certain components that may be included within a radio network controller (RNC) 2375. A radio network controller (RNC) 2375 is a governing element in the UMTS radio access network (UTRAN) that is responsible for controlling the base stations 2102 (or Node Bs 1102) that are connected to it. The radio network controller (RNC) 2375 may be connected to a circuit switched core network through a media gateway. The radio network controller (RNC) 2375 includes a processor 2303. The processor 2303 may be a general purpose single- or multi-chip microprocessor (e.g., an ARM), a special purpose microprocessor (e.g., a digital signal processor (DSP)), a microcontroller, a programmable gate array, etc. The processor 2303 may be referred to as a central processing unit (CPU). Although just a single processor 2303 is shown in the radio network controller (RNC) 2375 of FIG. 23, in an alternative configuration, a combination of processors (e.g., an ARM and DSP) could be used.

The radio network controller (RNC) 2375 also includes memory 2305. The memory 2305 may be any electronic component capable of storing electronic information. The memory 2305 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 2307a and instructions 2309a may be stored in the memory 2305. The instructions 2309a may be executable by the processor 2303 to implement the methods disclosed herein. Executing the instructions 2309a may involve the use of the data 2307a that is stored in the memory 2305. When the processor 2303 executes the instructions 2309a, various portions of the instructions 2309b may be loaded onto the processor 2303, and various pieces of data 2307b may be loaded onto the processor 2303.

The radio network controller (RNC) 2375 may also include a transmitter 2311 and a receiver 2313 to allow transmission and reception of signals to and from the radio network controller (RNC) 2375. The transmitter 2311 and receiver 2313 may be collectively referred to as a transceiver 2315. Multiple antennas 2317a-b may be electrically coupled to the transceiver 2315. The radio network controller (RNC) 2375 may also include (not shown) multiple transmitters, multiple receivers, multiple transceivers and/or additional antennas.

The radio network controller (RNC) 2375 may include a digital signal processor (DSP) 2321. The radio network controller (RNC) 2375 may also include a communications interface 2323. The communications interface 2323 may allow a user to interact with the radio network controller (RNC) 2375.

The various components of the radio network controller (RNC) 2375 may be coupled together by one or more buses, which may include a power bus, a control signal bus, a status signal bus, a data bus, etc. For the sake of clarity, the various buses are illustrated in FIG. 23 as a bus system 2319.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 3, 6, 13, 14, 16, 17 and 19, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for signaling multiple-user multiple-input and multiple-output in a high speed packet access system, comprising:
determining a multiple-user multiple-input and multiple-output parameter;
generating a message that comprises the multiple-user multiple-input and multiple-output parameter; and
sending the message to a wireless device.

2. The method of claim 1, wherein the method is performed by a radio network controller, wherein the wireless device is a Node B that forwards the message to a user equipment, wherein the multiple-user multiple-input and multiple-output parameter comprises a user equipment multiple-user multiple-input and multiple-output configuration required of the user equipment to support multiple-user multiple-input and multiple-output operations, and wherein the message is a radio resource control message.

3. The method of claim 2, wherein the multiple-user multiple-input and multiple-output parameter further comprises a channel quality indicator report configuration.

4. The method of claim 2, wherein the multiple-user multiple-input and multiple-output parameter further comprises a high-speed shared control channel fields reinterpretation.

5. The method of claim 1, wherein the method is performed by a user equipment, and wherein the wireless device is a Node B that forwards the message to a radio network controller.

6. The method of claim 5, wherein the multiple-user multiple-input and multiple-output parameter comprises a multiple-user multiple-input and multiple-output operation capability of the user equipment, and wherein the message is a radio resource control message.

7. The method of claim 5, wherein the multiple-user multiple-input and multiple-output parameter comprises a multiple-user multiple-input and multiple-output capable user equipment category.

8. The method of claim 1, wherein the method is performed by a Node B, wherein the wireless device is a radio network controller, and wherein the multiple-user multiple-input and multiple-output parameter comprises a Node B multiple-user multiple-input and multiple-output scheduling capability.

9. The method of claim 1, wherein the method is performed by a radio network controller, wherein the wireless device is a Node B, and wherein the multiple-user multiple-input and multiple-output parameter comprises a multiple-user multiple-input and multiple-output capability and configuration of a user equipment being served by the Node B.

10. The method of claim 9, wherein the multiple-user multiple-input and multiple-output parameter further comprises a new high-speed shared control channel fields encoding.

11. The method of claim 1, wherein the method is performed by a Node B, wherein the wireless device is a user equipment, and wherein the multiple-user multiple-input and multiple-output parameter comprises multiple-user multiple-input and multiple-output scheduling information, wherein new multiple-user multiple-input and multiple-output scheduling information is sent for each transmission time interval.

12. The method of claim 11, wherein the multiple-user multiple-input and multiple-output scheduling information is sent via a high-speed shared control channel on a common high speed downlink shared channel—radio network temporary identifier.

13. The method of claim 11, wherein the multiple-user multiple-input and multiple-output scheduling information is sent via fields of a Type-3 dual stream high-speed shared control channel, wherein the fields comprise certain bits of a channelization code.

14. The method of claim 11, wherein the multiple-user multiple-input and multiple-output scheduling information is sent via fields of a Type-3 dual stream high-speed shared control channel, wherein the fields comprise a combination of a secondary transport block size being set to 111111 and a corresponding redundancy version being set to 0.

15. The method of claim 11, wherein the user equipment is transmit antenna array capable, and wherein the multiple-user multiple-input and multiple-output scheduling information is sent via a combination of a modulation scheme and a number of transport blocks in a high-speed shared control channel.

16. The method of claim 11, wherein the user equipment is transmit antenna array capable, and wherein the multiple-user multiple-input and multiple-output scheduling information is sent via a hybrid automatic repeat request processing identification in a high-speed shared control channel.

17. The method of claim 1, wherein the method is performed by a Node B, wherein the wireless device is a user equipment, wherein the multiple-user multiple-input and multiple-output parameter comprises a command to activate/deactivate multiple-user multiple-input and multiple-output operations on the user equipment, and wherein the message comprises a high-speed shared control channel order.

18. The method of claim 17, wherein the high-speed shared control channel order further comprises a channel quality indicator reporting change for the user equipment.

19. The method of claim 17, wherein the high-speed shared control channel order further comprises a high-speed shared control channel fields interpretation change for the user equipment.

20. A wireless device configured for signaling multiple-user multiple-input and multiple-output in a high speed packet access system, comprising:
a processor;
memory in electronic communication with the processor;
instructions stored in the memory, the instructions being executable by the processor to:
determine a multiple-user multiple-input and multiple-output parameter;
generate a message that comprises the multiple-user multiple-input and multiple-output parameter; and
send the message to a second wireless device.

21. The wireless device of claim 20, wherein the wireless device is a radio network controller, wherein the second wireless device is a Node B that forwards the message to a user equipment, wherein the multiple-user multiple-input and multiple-output parameter comprises a user equipment multiple-user multiple-input and multiple-output configuration required of the user equipment to support multiple-user multiple-input and multiple-output operations, and wherein the message is a radio resource control message.

22. The wireless device of claim 21, wherein the multiple-user multiple-input and multiple-output parameter further comprises a channel quality indicator report configuration.

23. The wireless device of claim 21, wherein the multiple-user multiple-input and multiple-output parameter further comprises a high-speed shared control channel fields reinterpretation.

24. The wireless device of claim 20, wherein the wireless device is a user equipment, and wherein the second wireless device is a Node B that forwards the message to a radio network controller.

25. The wireless device of claim 24, wherein the multiple-user multiple-input and multiple-output parameter comprises a multiple-user multiple-input and multiple-output operation capability of the user equipment, and wherein the message is a radio resource control message.

26. The wireless device of claim 24, wherein the multiple-user multiple-input and multiple-output parameter comprises a multiple-user multiple-input and multiple-output capable user equipment category.

27. The wireless device of claim 20, wherein the wireless device is a Node B, wherein the second wireless device is a radio network controller, and wherein the multiple-user multiple-input and multiple-output parameter comprises a Node B multiple-user multiple-input and multiple-output scheduling capability.

28. The wireless device of claim 20, wherein the wireless device is a radio network controller, wherein the second wireless device is a Node B, and wherein the multiple-user multiple-input and multiple-output parameter comprises a multiple-user multiple-input and multiple-output capability and configuration of a user equipment being served by the Node B.

29. The wireless device of claim 28, wherein the multiple-user multiple-input and multiple-output parameter further comprises a new high-speed shared control channel fields encoding.

30. The wireless device of claim 20, wherein the wireless device is a Node B, wherein the second wireless device is a user equipment, and wherein the multiple-user multiple-input and multiple-output parameter comprises multiple-user multiple-input and multiple-output scheduling information, wherein new multiple-user multiple-input and multiple-output scheduling information is sent for each transmission time interval.

31. The wireless device of claim 30, wherein the multiple-user multiple-input and multiple-output scheduling information is sent via a high-speed shared control channel on a common high speed downlink shared channel—radio network temporary identifier.

32. The wireless device of claim 30, wherein the multiple-user multiple-input and multiple-output scheduling information is sent via fields of a Type-3 dual stream high-speed shared control channel, wherein the fields comprise certain bits of a channelization code.

33. The wireless device of claim 30, wherein the multiple-user multiple-input and multiple-output scheduling information is sent via fields of a Type-3 dual stream high-speed shared control channel, wherein the fields comprise a combination of a secondary transport block size being set to 111111 and a corresponding redundancy version being set to 0.

34. The wireless device of claim 30, wherein the wireless device is transmit antenna array capable, and wherein the multiple-user multiple-input and multiple-output scheduling information is sent via a combination of a modulation scheme and a number of transport blocks in a high-speed shared control channel.

35. The wireless device of claim 30, wherein the wireless device is transmit antenna array capable, and wherein the multiple-user multiple-input and multiple-output scheduling information is sent via a hybrid automatic repeat request processing identification in a high-speed shared control channel.

36. The wireless device of claim 20, wherein the wireless device is a Node B, wherein the second wireless device is a user equipment, wherein the multiple-user multiple-input and multiple-output parameter comprises a command to activate/deactivate multiple-user multiple-input and multiple-output operations on the user equipment, and wherein the message comprises a high-speed shared control channel order.

37. The wireless device of claim 36, wherein the high-speed shared control channel order further comprises a channel quality indicator reporting change for the user equipment.

38. The wireless device of claim 36, wherein the high-speed shared control channel order further comprises a high-speed shared control channel fields interpretation change for the user equipment.

39. A wireless device configured for signaling multiple-user multiple-input and multiple-output in a high speed packet access system, comprising:
means for determining a multiple-user multiple-input and multiple-output parameter;
means for generating a message that comprises the multiple-user multiple-input and multiple-output parameter; and
means for sending the message to a wireless device.

40. A computer-program product for signaling multiple-user multiple-input and multiple-output in a high-speed packet access system, the computer-program product comprising a non-transitory computer-readable medium having instructions thereon, the instructions comprising:
code for causing a first wireless device to determine a multiple-user multiple-input and multiple-output parameter;
code for causing a first wireless device to generate a message that comprises the multiple-user multiple-input and multiple-output parameter; and
code for causing the first wireless device to send the message to a second wireless device.
